(19) United States
(12) Patent Application Publication
(10) Pub. No.: US 2023/0239702 A1
(43) Pub. Date: Jul. 27, 2023

(54) APPARATUS AND METHODS FOR WIRELESS DATA COMMUNICATION USING SPECTRUM WHITE SPACES

(71) Applicant: THE UNIVERSITY COURT OF THE UNIVERSITY OF EDINBURGH, Edinburgh (GB)

(72) Inventors: Mahesh Kumar MARINA, Edinburgh (GB); Mohamed Mostafa KASSEM, Edinburgh (GB); Morteza KHEIRKHAH SABETGHADAM, Edinburgh (GB)

(21) Appl. No.: 18/001,363

(22) PCT Filed: Jun. 4, 2021
(86) PCT No.: PCT/GB2021/051384

§ 371 Date: Dec. 9, 2022

(30) Foreign Application Priority Data
Jun. 12, 2020 (GB) 2009006.4

(51) Int. Cl. H04W 16/14

(52) U.S. Cl. CPC H04W 16/14; H04W 80/06

(57) ABSTRACT

There is described a computer implemented method for efficient aggregation of a Television White Space (TVWS) spectrum for backhaul use, said method comprising: providing a TVWS conversion substrate with a single antenna for combining multiple non-contiguous chunks of TVWS spectrum with said single antenna; providing a Multi-Path transport protocol; and providing an uncoupled, cross-layer congestion control algorithm for Multi-path Transmission Control Protocol (MPTCP).

### FIELD

The present invention concerns the use of spectrum white spaces for wireless data communications in general and the use of the TV white space (TVWS) spectrum in particular, for example to provide low-cost backhaul in rural and developing regions. This is in view of certain attractive properties of TVWS spectrum for this use case in terms of available spectrum, cost of spectrum access and favorable propagation characteristics. The invention involves a system, referred to generally herein as “WhiteHaul”, for efficient aggregation of TVWS spectrum tailored for the backhaul use case.

### 1. BACKGROUND

The beneficial impacts with Internet connectivity have been well documented [58](See References at the end of this description). For example, according to World Bank estimates, every 10% increase in broadband (high-speed) Internet access translates to 1-2% rise in gross domestic product (GDP). However, almost half the world's population is still unconnected [11]. And almost half the world's population is still rural. The major challenge is the lack of infrastructure to connect the sparsely populated or low-income rural and developing regions [43, 16, 65]. More concretely, the problem is about economically provisioning backhaul networks that connect access (last-mile) networks to the wider Internet [53, 40, 45]. Traditional approaches for backhaul connectivity rely on fiber, licensed microwave or satellite solutions that are associated with high (CAPEX/OPEX) costs [69]. The present invention seeks to exploit spectrum white spaces towards low cost backhaul for underserved regions. Preferred embodiments of the invention focus on the TV white space (TVWS) spectrum—the portions of UHF TV bands unused by TV transmitters and wireless microphone users (the primary users of this spectrum). Led by the U.S. in 2008, several countries have made the TVWS spectrum unlicensed (like with Wi-Fi devices) subject to interference protection for primary users (e.g., TV receivers) by consulting a geo-location database for available spectrum at a given location and time. TVWS spectrum is attractive for backhaul connectivity in rural and developing regions for multiple reasons. First, there is a large amount of TVWS spectrum available in rural areas (in the region of 200+ MHz) with fewer TV transmitters and rare wireless microphone use, as also shown in FIG. 1 for one case study country. In developing countries, almost all of the UHF band is available as white space due to non-existent or limited presence of over-the-air TV. Availability of ample spectrum is a crucial aspect for backhaul connections that need to handle aggregated local access network traffic. Recent regulatory developments (e.g., [54]) suggest that even 700 MHz spectrum that is being licensed to mobile network operators could be accessible by others for a small license fee in areas where it is unused. Second, TVWS spectrum is almost free spectrum, dramatically reducing the operational network costs compared to using licensed spectrum alternatives. Third, UHF TV spectrum has superior propagation characteristics compared to other higher frequency bands in terms of range and non-line-of-sight (NLOS) propagation in presence of foliage and obstructions. Longer range and NLOS propagation aspects have been highlighted and experimentally validated in prior work [17, 26, 39, 40, 45]. For example, it is possible to get 4 times greater range with TVWS spectrum compared to 2.4 GHz unlicensed spectrum used by Wi-Fi [17, 40]. This suggests lower infrastructure costs as fewer number of relays are sufficient to enable backhaul connectivity over long distances. NLOS propagation possible with TVWS spectrum leads to another not so apparent cost advantage compared to other bands, which is the reduction in required tower height [45]; a 10-15 m tower is an order-of-magnitude cheaper than a 45 m tower that may provide LoS [57]. These benefits make the case for using TVWS spectrum for the backhaul problem stronger when taken together with the fact that 20 Km long operational TVWS links have been realized in practice and that recent population distribution studies show that nearly 97% of the global population lives within 40 Kms of a major city typically with fiber connectivity [27].

However exploiting TVWS spectrum for point-to-point (PtP) backhaul links present several significant challenges as discussed further below. First, TVWS spectrum is available in units of relatively small sized channels (6/8 MHz) depending on the regulatory regime. Second, available channels may not be contiguous depending on the presence of primary users (e.g., TV transmitters). So it is imperative to aggregate multiple possibly non-contiguous TVWS channels to realize high-speed TVWS backhaul connectivity. Third, from an ease of deployment and cost perspective, use of single antenna at each backhaul endpoint is preferable even when using multiple interfaces, as previously also articulated in [62]. Fourth, TVWS spectrum exhibits a high degree of diversity in terms of chunk sizes, power asymmetry and interference levels, especially for long-distance backhaul communications, and these need to be taken into account in any backhaul solution design. Lastly, backhaul traffic can also be highly asymmetric and exhibit temporal fluctuations.

The present application discloses a WhiteHaul system for low-cost PtP backhaul over TVWS spectrum that addresses the aforementioned challenges. Specifically:
Considering a representative country, a case study is presented with an extensive analysis of salient aspects of TVWS spectrum characteristics from a backhaul use case perspective as well as an analysis of real-world rural backhaul traffic characteristics (S.2).
Informed by the above analysis, a design and implementation of the WhiteHaul system is described (S.3 and S.4) that features several innovative features spanning both hardware and software. Chief among them are: (i) a TVWS conversion substrate that can effectively combine multiple non-contiguous chunks of TVWS spectrum with a single antenna while leveraging multiple low cost, standard Wi-Fi cards conforming to the IEEE 802.11 standard, such as 802.11n/ac Wi-Fi cards; (ii) novel use of MPTCP as an abstraction of a high-speed link-level tunnel, efficiently aggregating multiple TVWS spectrum chunks, aided by a novel uncoupled and cross-layer congestion control algorithm.
WhiteHaul is evaluated using the prototype implementation and simulations driven by real-world backhaul traffic traces to quantify the aggregated backhaul data rates it can achieve in different configurations and link conditions (S.5). In particular, it is shown that WhiteHaul can aggregate almost the whole of TV band with three interfaces and achieve nearly 600 Mbps TCP throughput. WhiteHaul MPTCP congestion control algorithm is also shown to provide an order of magnitude improvement over the state of the art algorithms in the presence of typical loss rates experienced by TVWS backhaul links.

WhiteHaul is believed to be the first system to target the backhaul PtP use case and show significant 500 Mbps+ data rates through aggregation of large amount of possibly non-contiguous TVWS spectrum, although the promise of TVWS spectrum for backhaul connectivity in rural and developing regions has been previously recognized in the literature [46, 40, 45, 41]. By targeting the backhaul PtP use case, it also complements the extensive TVWS systems research to date aimed at several other use cases (e.g., Wi-Fi like wireless LANs [14, 23, 70, 71], point-to-multipoint (PtMP) of TVWS for agriculture, sensor, IoT and other applications [61, 67, 62]. NLoS propagation capabilities of TVWS make this work complementary to prior long-distance Wi-Fi research (e.g., [56]. The use of TVWS for backhaul communications in general and WhiteHaul in particular also compares favourably, especially in terms of cost and ease of deployment, with respect to alternative technologies being explored for addressing connectivity challenges in rural and developing regions (e.g., drones [4], free space optical communications [5], Google Project Loon [43], millimeter waves [50]).

2 TVWS Backhaul Links: Characteristics and Challenges

As a way to substantiate the challenges associated with using TVWS spectrum for rural backhaul links, this section presents a case study considering a representative European country and examines the nature of TVWS spectrum in the 470-790 MHz TV band as per the ETSI Harmonised Standard for White Space Devices [22].

Available spectrum. We first analyze the amount of TVWS spectrum available in different types of areas in the case study country, classified based on the population density—rural, suburban and urban areas, respectively, correspond to areas with population less than 3000, more than 10000 and more than 125000, as per the area classification in this country. We estimate the available TVWS spectrum in these three area types at the pixel level, where each pixel is of size 6KM\hat{ }2 (corresponding to the intersection of three degrees in latitude and three degrees in longitude). For the center location of each such pixel, we query a commercial geolocation database to obtain the available TV channels at that location along with allowed power levels. FIG. 1 shows the cumulative distribution function (CDF) of TVWS spectrum availability for the three area types. These results show that the whole TV band is available in 70% of the rural locations, which is due to the fewer number of primary digital terrestrial television (DTT) transmitters in those areas. Note that the results in FIG. 1 are broadly in agreement with those reported by prior TVWS spectrum availability studies (e.g., [33, 66]).

Spectrum fragmentation. To understand TVWS spectrum characteristics in rural areas, consideration is given firstly to the extent to which the available TVWS spectrum is fragmented. For this, a spectrum chunk is defined as a set of contiguous TVWS channels available at a given location. FIG. 2(b) quantifies the extent to which TVWS is fragmented even in rural areas. For example, in 60% of the locations, the spectrum is fragmented into at least 6 chunks and in only 20% of the locations the spectrum is available in 4 or fewer chunks. Such high degree of spectrum fragmentaton is due to the presence of multiple lower power TV relays/amplifiers to extend the coverage of the primary digital terrestrial television (DTT) transmitters. This creates gaps in available TVWS spectrum as access to channels amplified by such relays are restricted by the geolocation database.

Spectrum chunk size diversity. FIG. 2(a) shows how the spectrum is distributed across chunks through CDFs of the percentage of total available spectrum that is covered by the largest chunk, two largest chunks, three largest chunks and so on. We observe that only about half the available spectrum is covered by the largest chunk (top curve of FIG. 2(b)) in half the locations, and that even top four chunks combined cannot cover all the available spectrum in 80% of the locations. Distribution of chunk sizes within each of the four largest sized chunks is shown in FIG. 2(c)-(f). These results demonstrate the significant diversity in chunk sizes, which adds further complexity to the problem of aggregating TVWS spectrum on top of its non-contiguous nature.

Power asymmetry. With TVWS spectrum, given that the geolocation database needs to be queried to determine the available set of channels and power levels at a location, it is possible that these could be substantially different between backhaul link endpoints that are spaced apart. The potential power asymmetry resulting from this issue are shown in in FIG. 3 for the case study country. FIG. 3A shows the allowed power level differences for different link distances for each channel in the common set of channels available at both ends of the link. The power differences can be quite significant for longer (20 Km) links with a median around 25 dB. This effect is seen for shorter (5 Km) links too where only in 10% of the cases transmit power difference is less than 6 dB. Power differences can also be there between different channels available at a link endpoint. This effect is quantified in FIG. 3B, where maximum power differences between channels in each of the four largest chunks is shown. It can be seen that channels within a chunk can have quite different power levels; for example, median power difference within 1st and 2nd chunks are around 12 dB. Note that this power asymmetry effect is unique to TVWS based backhaul setting and not present in other approaches used in the literature for low-cost backhaul such as long-distance Wi-Fi [56, 64, 25, 21, 55, 60]. As such, the set of chunks and their size need to be carefully chosen to minimize the power asymmetry effect. Moreover, time allocation for each end of a backhaul link needs to account for effective capacity of the link and traffic demand from each direction, the former affected by transmit power used for each of the chunks. This is addressed this in the design in section 4.2.

Interference. While consulting the geolocation database is mandatory to access the TVWS spectrum, it cannot capture receiver side interference characteristics that could affect the quality of TVWS transmission from a further away transmitter. To illustrate this point, suppose a TVWS receiver at the rooftop of an office building and consider a transmitter on top of another building 3 Kms away. Based on available TVWS channels and allowed power levels by querying the geolocation database, accounting for pathloss using the SPLAT! RF planning tool [38] and antenna gains, we obtain expected signal power at the receiver on channels available at transmitter side as shown in FIGS. 4A and 4B. At the receiver side, a low-cost spectrum analyzer can be used [9] to estimate the level of interference across the whole TV band, also shown in the same figure. By overlaying both these on the same figure, it can be seen that not all channels available at the transmitter side are the same from the receiver perspective, highlighting the importance of receiver-side interference measurement, for which low-cost spectrum analyzers are valuable.

Traffic characteristics. Effective backhaul network design requires a good understanding of the characteristics of traffic it is expected to carry. To this end, the case study collected trace of traffic from a long-running rural community wireless access network in the case study country as seen by its leased fiber backhaul link with 200 Mbps symmetric upstream and downstream bandwidth limit. This network serves at least 250 households and local businesses. FIG. 5 shows a week-long backhaul traffic profile in the downstream (towards access network) and upstream directions. We observe a high degree of asymmetry with average daily downstream traffic much higher, around 63 GBytes, compared to average upstream traffic each day (only about 4 GBytes). We also notice that, although there is some apparent diurnal patterns, traffic in both directions fluctuates substantially over time. To understand the degree of fluctuation at different time granularities (epochs), FIG. 5 shows the CDF of variation in downstream traffic from one epoch to the next for different epoch lengths. These results indicate considerable degree of traffic variation for longer epochs but marginal variation with the smallest epoch size available for this trace, which is based on data collected every 30 seconds.

### SUMMARY OF THE INVENTION

At the core of WhiteHaul are three key innovative features:
(i) a TVWS conversion substrate that can effectively combine multiple non-contiguous chunks of TVWS spectrum with a single antenna while leveraging multiple low cost Wi-Fi cards based on IEEE 802.11 standard
(ii) novel use of Multi-Path transport protocol, specifically, Multi-path Transmission Control Protocol (MPTCP) to efficiently aggregate multiple TVWS spectrum chunks, aided by a novel uncoupled and cross-layer congestion control algorithm.
(iii) A novel algorithm that incorporates a geolocation database, spectrum analyzer, and RF signal propagation, loss, and terrain analysis tool to decide on the list of TVWS contiguous and non-contiguous chunks that can be used in given setup

A prototype implementation of WhiteHaul, shows that WhiteHaul can aggregate almost the whole of TV band with three WiFi interfaces and achieve nearly 600 Mbps TCP throughput. The WhiteHaul MPTCP congestion control algorithm can provide an order of magnitude improvement over the state of the art algorithms in the presence of typical loss rates experienced by TVWS backhaul links.

The invention includes:
apparatus, systems and devices as described herein;
computer-implemented methods as described herein;
computing devices and/or systems programmed, configured or otherwise adapted for implementing those methods; data processing apparatus and/or devices and/or systems comprising means for carrying out the methods; data processing apparatus and/or devices and/or systems comprising a processor adapted or configured to perform the methods;
computer program products for implementing those methods, including: computer program products comprising instructions which, when the program is executed by a computer, cause the computer to carry out the methods; computer-readable storage media comprising instructions which, when executed by a computer, cause the computer to carry out the methods; computer-readable data carriers having stored thereon the computer program products; data carrier signals carrying the computer program; and non-transitory computer readable media having stored thereon software instructions that, when executed by a processor, cause the processor to carry out the methods.

According to a first aspect of the invention there is provided a computer implemented method for efficient aggregation of a Television White Space (TVWS) spectrum for backhaul use, said method comprising: providing a TVWS conversion substrate with a single antenna for combining multiple non-contiguous chunks of TVWS spectrum with said single antenna; providing a Multi-Path transport protocol; and providing an uncoupled, cross-layer congestion control algorithm for Multi-path Transmission Control Protocol (MPTCP).

Preferably, the method comprises a further step of providing an algorithm that incorporates a geolocation database, spectrum analyser and radio frequency (RF) signal propagation, loss and terrain analysis tool to decide on the list of TVWS contiguous and non-contiguous chunks that can be used in given setup.

Preferably, the step of providing a Multi-Path transport protocol comprises providing a Multi-Path transport protocol based software layer aggregation of multiple TVWS spectrum chunks.

Preferably, the Multi-Path transport protocol is a Multi-Path Transmission Control Protocol (MPTCP).

Preferably, the single antenna is a dual polarised antenna.

Preferably, the single antenna has a height, and the height is no more than 125 m. More preferably, the single antenna has a height that is not more than 100 m. Still more preferably, the single antenna has a height that is not more than 30 m. The method allows for a reduced antenna height to be utilised. It is understood that antenna height is dependent on regional and national standards and regulations.

Preferably, the method further comprises providing a software-defined radio (SDR)-based local oscillator. Preferably, the method further comprises providing a voltage controlled oscillator (VCO). Preferably, the method further comprises providing a local oscillator (LO). Alternatively, any suitable oscillator may be provided.

Preferably, the method further comprises providing at least one Wi-Fi interface based on IEEE 802.11 standard operating in the 5 GHz band. For example, the Wi-Fi interface may comprise at least one 802.11n/ac W-Fi card.

Preferably, the method further comprises providing a long range (LoRa) control interface.

According to a second aspect of the invention, there is provided a computing system programmed, configured or otherwise adapted for implementing the method according to the first aspect of the invention.

According to a third aspect of the invention, there is provided a data processing apparatus comprising means for carrying out the method of the first aspect of the invention.

According to a fourth aspect of the invention, there is provided a data processing apparatus comprising a processor adapted or configured to perform the method according to the first aspect of the invention.

According to a fifth aspect of the invention, there is provided a data processing apparatus comprising means for carrying out the method according to the first aspect of the invention.

According to a sixth aspect of the invention, there is provided a computer program product comprising instructions which, when the program is executed by a computer, cause the computer to carry out the method according to the first aspect of the invention.

According to a seventh aspect of the invention, there is provided a computer-readable medium comprising instructions which, when executed by a computer, cause the computer to carry out the method according to the first aspect of the invention.

According to a eighth aspect of the invention, there is provided a computer-readable data carrier, having stored thereon the computer program product according to the sixth aspect of the present invention.

According to a eighth aspect of the invention, there is provided a data carrier signal carrying the computer program product according to the sixth aspect of the present invention.

According to a ninth aspect of the invention, there is provided a non-transitory computer readable media having stored thereon software instructions that, when executed by a processor, cause the processor to carry out the method according to the first aspect of the invention.

### BRIEF DESCRIPTION OF THE DRAWINGS

Embodiments of the invention will now be described, with reference to the accompanying drawings, in which:

FIG. 1 illustrates TVWS spectrum availability distribution in different types of areas in the case study country.

FIG. 2 illustrates (a) the percentage of largest 4 chunks of the spectrum to the total amount of available spectrum. (b) shows the CDF of number of spectrum chunks across different locations. Distribution of the size of the 4 largest spectrum chunks in (c), (d), (e) and (f).

FIG. 3 illustrates power asymmetry effect at different link distances and between channels within spectrum chunks.

FIGS. 4A and 4B illustrates spectrum occupancy as measured by a spectrum analyzer at a receiver. The points are the estimated received power from a remote TVWS transmitter.

FIG. 5 illustrates weekly backhaul traffic volumes for a rural community wireless network: (a) downstream and (b) upstream.

FIG. 5 further illustrates downstream traffic volume variation (in MBytes) between consecutive epochs for different epoch lengths. by addressing the multiple associated challenges outlined at the outset.

FIG. 6 is a high-level schematic illustration of a WhiteHaul link in accordance with an embodiment of the invention.

FIG. 7 illustrates a WhiteHaul node architecture in accordance with an embodiment of the invention.

FIG. 8 is a schematic illustration of a WhiteHaul TVWS conversion substrate in accordance with an embodiment of the invention.

FIG. 9 is a schematic illustration of a complete WhiteHaul endpoint system (node) in accordance with an embodiment of the invention.

FIG. 10 is a schematic illustration of examples of WhiteHaul backhaul links in accordance with embodiments of the invention.

FIGS. 11A and 11B shows a comparison of (a) down-converted signal using VCO with (b) that of a software-defined radio (SDR)-based local oscillator (LO) approach in accordance with an embodiment of the invention.

FIG. 12 illustrates WhiteHaul aggregate TCP throughput performance in all two and three interface scenarios: (a) and (c), and WhiteHaul conversion and aggregation efficiency as percentage of best case in all two and three interface scenarios: (b) and (d).

FIG. 13 illustrates performance benefit with WhiteHaul dynamic time slot allocation compared to a commonly used static, half-split approach: (a) the amount of backlogged traffic per epoch for a one week period; (b) CDFs of backlogged traffic for both approaches.

FIG. 14 illustrates (a) packet loss rate and (b) effective capacity at different link qualities (RSS values) and channel widths.

FIG. 15 illustrates aggregation efficiency comparison between (c) WhiteHaul MPTCP, (a) uncoupled MPTCP with CUBIC [29] congestion control and (b) coupled MPTCP with OLIA [42] congestion control algorithm, in different conditions shown as a heatmap—darker is better.

FIGS. 16 to 22 provide further details of the present invention.

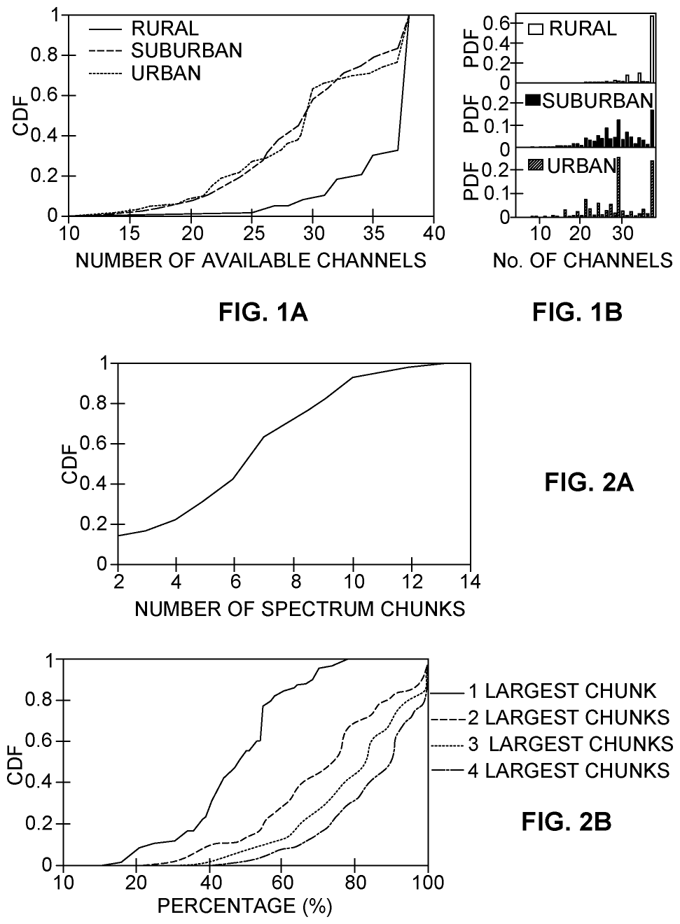

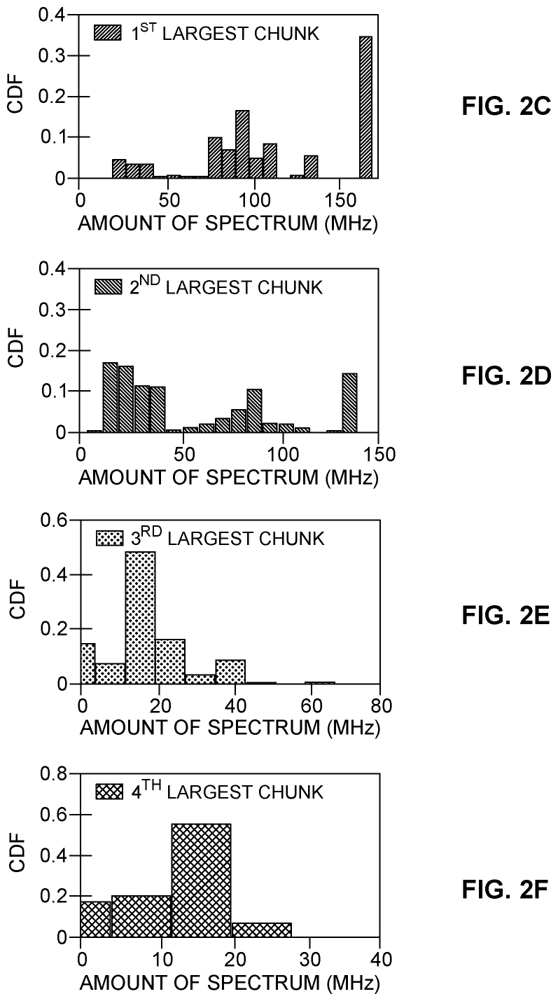

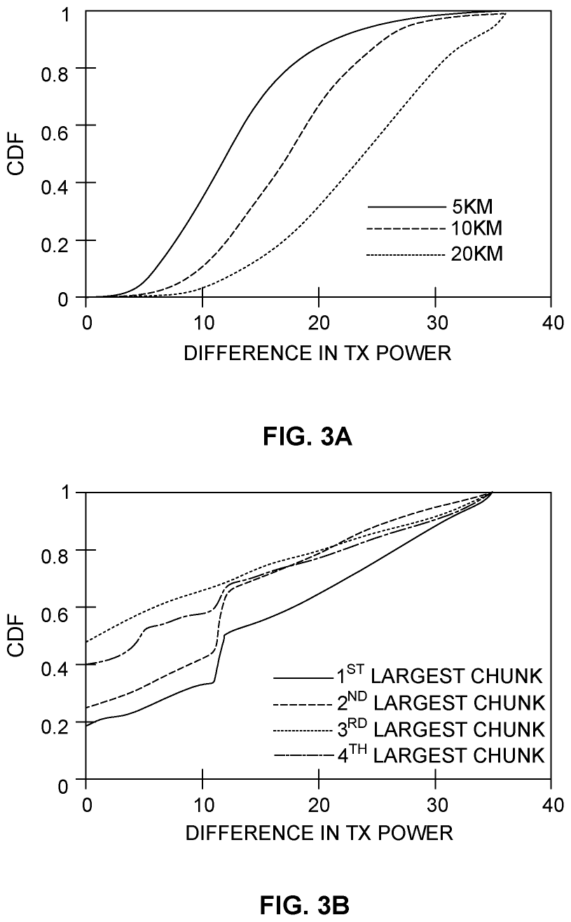

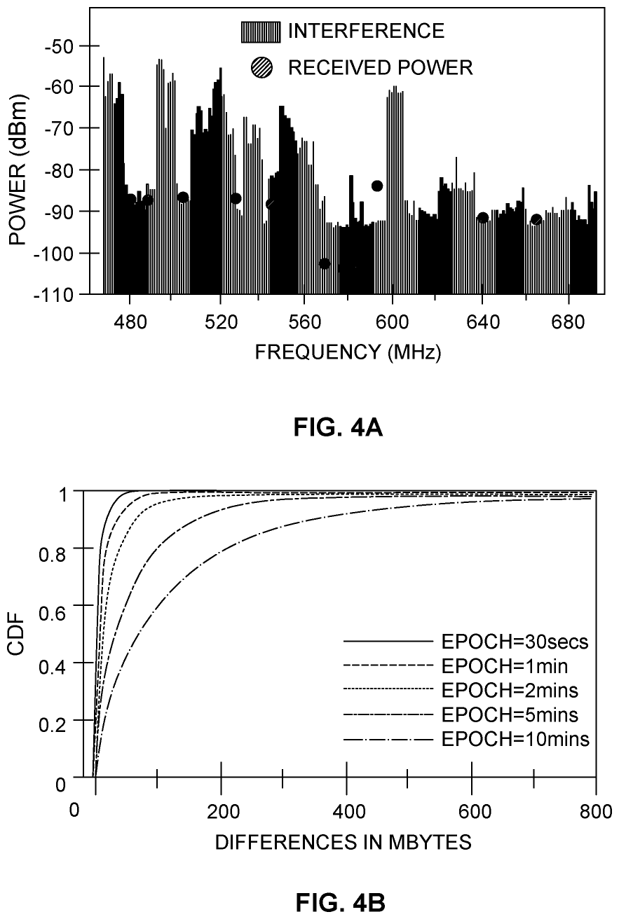

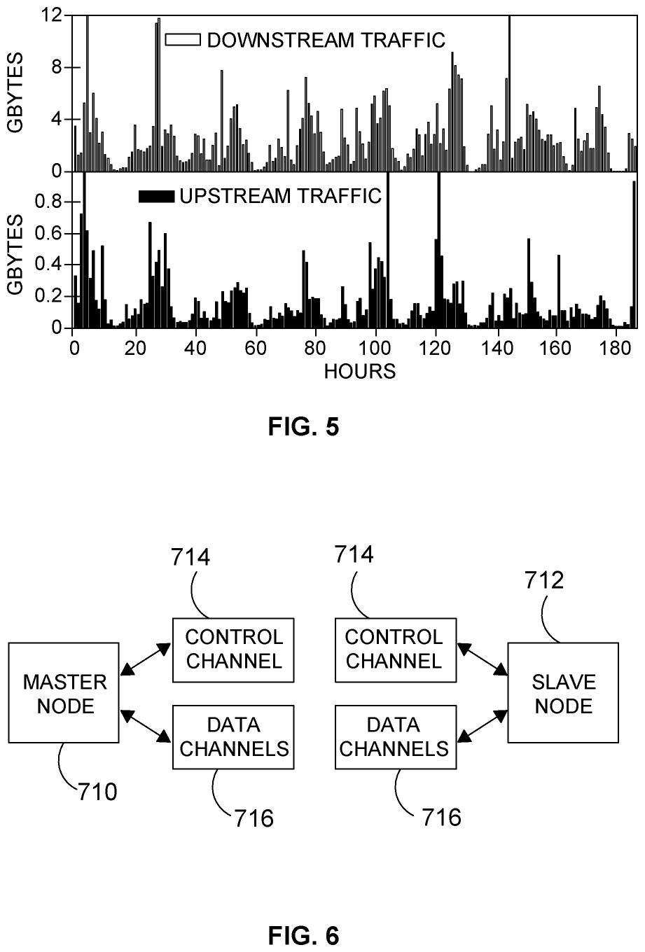

### WHITEHAUL OVERVIEW

There follows a high-level overview of the WhiteHaul system according to an embodiment of the invention that is aimed at exploiting TVWS spectrum towards a low-cost backhaul solution for rural and developing regions, by addressing the multiple associated challenges outlined above.

WhiteHaul is a system to realize point-to-point (PtP) backhaul links, meaning a WhiteHaul node forms the endpoint of such a link. As shown in FIG. 6, a master-slave model is adopted in WhiteHaul in that one end of the PtP link acts as the Master Node 710 and the other as the Slave Node 712 with the former responsible for link configuration decisions (e.g., spectrum to use for interfaces on both sides). The Master and Slave coordinate over an out-of-band control channel 714 while carrying user traffic over multiple data channels 716 that each operate on a separate TVWS spectrum chunk. There are as many data channels as the number of interfaces at each of the WhiteHaul end nodes making up the link. For reasons elaborated later in section 4.2, WhiteHaul links operate in time-division duplexing (TDD) mode, meaning the Master and Slave take turns in time, possibly of different slot lengths (as discussed further below), to communicate over their respective data interfaces.

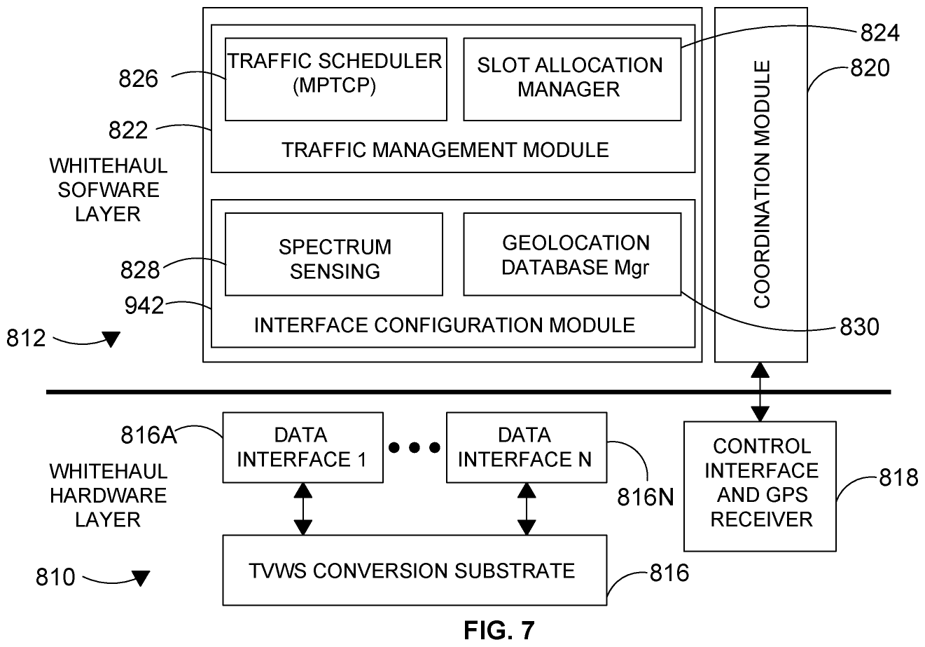

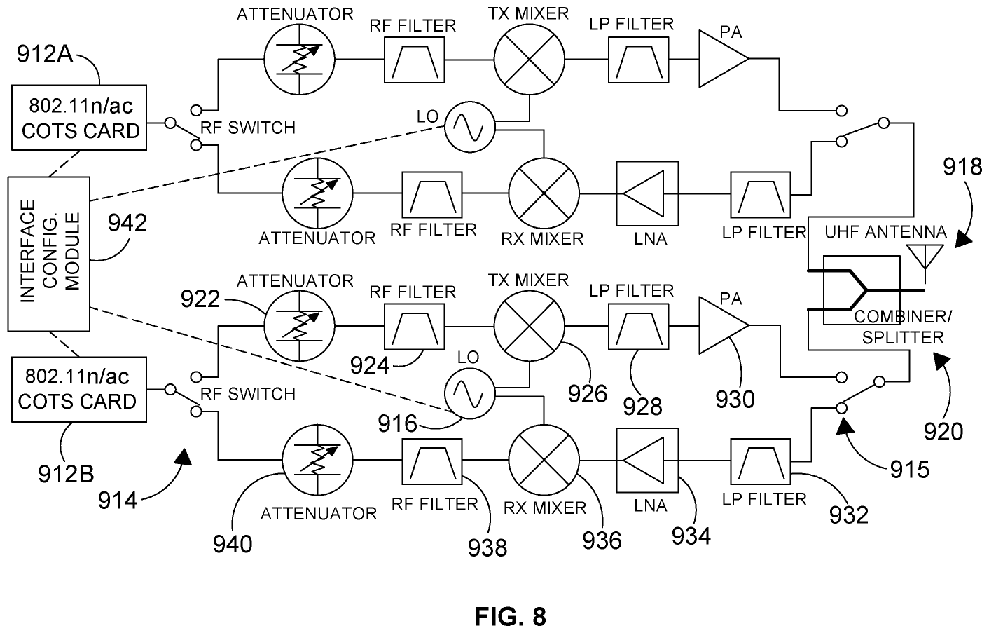

A schematic of the WhiteHaul node architecture is shown in FIG. 7, which essentially consists of two layers: the Hardware Layer 810 and the Software Layer 812. The hardware layer 810 is composed of a plurality of physical wireless (WiFi) interfaces 912A —912N (see FIG. 8) used for both control and data communication (the control channel 714 and data channels 716 of FIG. 6) as well as a TVWS conversion substrate 816 for the data interfaces 814A —814N and a control interface and GPS receiver 818. The WiFi interfaces 912A —912N preferably use commodity off-the-shelf (COTS) 802.11n/ac Wi-Fi cards operating in 5 GHz band. The conversion substrate 816 is responsible for frequency up/down conversion between available TVWS spectrum chunks and 5 GHz Wi-Fi channels.

The control interface 818 preferably uses LoRa [59], a low-power wide area network (LPWAN) technology, that costs a few dollars a piece, operates in unlicensed sub-GHz bands, and provides data rates of few tens of Kbps over long distances up to Km.

The WhiteHaul software layer 812 orchestrates the underlying interfaces 912A-912N to maximize the overall system performance. In this embodiment it is made up of three modules:

(i) a Coordination Module 820 facilitates communication between the Master and Slave ends via the underlying LoRa control interface 818.

(ii) an Interface Configuration Module 942 configures the TVWS spectrum chunks and transmit power of the data interfaces 814A —814N as decided by the Master, which bases it on the TVWS spectrum availability information obtained from the geolocation database as well as local low-cost spectrum sensing from both ends. The Interface Configuration Module 942 includes a spectrum sensing component and a geolocation database manager component 830.

(iii) a Traffic Management Module 822 performs two functions. One, by a Slot Allocation Manager 824, is to adapt the time slot duration for Master-Slave (forward) and Slave-Master (reverse) directions, every epoch, depending on the effective capacity and traffic demand of forward and reverse links. A Traffic Scheduler 826 is responsible for the other function: to efficiently schedule the traffic among the underlying data interfaces using a modified variant of MPTCP and aided by an advisory signal from the Slot Allocation Manager.

### 4 SYSTEM DESIGN AND IMPLEMENTATION

This section describes one embodiment of a WhiteHaul design and implementation in detail.

4.1 Hardware Layer

4.1.1 TVWS Conversion Substrate

As previously stated, this part of the hardware layer converts between 5 GHz and TVWS spectrum. FIG. 8 shows the schematic of its design for the case of two 802.11n/ac data interfaces 912A, 912B. The conversion substrate provides a transmit/receive (TX/RX) channel for each data interface 814 (each data channel 716). The number of TX/RX channels and associated data interfaces 814/912 can vary according to need, with a minimum of two. As noted elsewhere, three interfaces can aggregate almost the whole of the TV band and achieve nearly Mbps TCP throughput. As can be seen in FIG. 8, each of the TX/RX channels is identical and the following description referring to the channel associated with the first interface card 912A applies to the second channel associated with the second interface card 912B and any additional channels associated with additional interface cards.

In this embodiment, each TX/RX channel comprises a TX sub-channel, an RX sub-channel and a single local oscillator (LO) 916. One end of the TX/RX channel includes a first RF switch 914, by means of which the sub-channels can be connected alternately to the associated interface card 912. The other end of the TX/RX channel includes a second RF switch 915, by means of which the sub-channels can be connected alternately to a UHF antenna 918, via a combiner/splitter that allows the single antenna 918 to be shared between all of the TX/RX channels.

In use, at any given time each TX/RX channel is tuned by, means of the LO 916, to the centre frequency of a particular spectrum chunk. As discussed elsewhere, the spectrum chunks are assigned to the channels by consulting a geolocation database for available spectrum at a given location and time.

From left to right in FIG. 8, and as described in more detail below, the TX sub-channel comprises, in series, a first configurable RF attenuator 922 having its input connected to a first pole of the first RF switch 914, a first RF filter 924, a TX down-conversion mixer 926 driven by the LO 916, a first low pass (LP) filter 928 and a low noise power amplifier (PA) 930. The output of the PA 930 is connected to a first pole of the second RF switch 915.

From right to left in FIG. 8, and as described in more detail below, the RX sub-channel comprises, in series, a second LP filter 932 having its input connected to a second pole of the second RF switch 915, a low noise amplifier (LNA) 934, a RX up-conversion mixer 936, also driven by the LO 916, a second RF filter 938 and a second configurable RF attenuator 940 having its input connected to a second pole of the first RF switch 914.

As shown, the data interfaces 912 as well as the substrate, specifically the LO 916, are dynamically controlled by an Interface Configuration Module (942) to ensure compliance with TVWS spectrum regulations, set oscillator frequencies, channel bandwidths and so on. In general, a flexible and modular design for the substrate is preferable to allow its realization with replaceable/configurable components as per link requirements and cost considerations (e.g., trade off between noise and linearity).

A prototype implementation consists of a desktop computer (running Ubuntu Linux 14.04) connected to a set of Mikrotik RB922UAGS-5HPacD Router-Boards with 802.11n/ac cards, acting as data interfaces, via Gigabit Ethernet. The desktop also hosts a USRP B210 [10] per data interface for use as a local oscillator, as described below. Practical implementations may use any suitable data processing systems or components for implementing and executing the software layer 812, including general purpose or custom data processors, memory, operating systems etc. as will be well understood by persons skilled in the art and as further discussed elsewhere in this description.

Software-Defined Radio (SDR) Based Local Oscillator.

The LO component 916 plays a key role of translating RF/IF signals up/down to a different frequency band by multiplying the signal with the sinusoidal signal it generates. Previous works employing the frequency conversion concept (e.g., [13, 52]) have relied on Voltage Controlled Oscillators (VCOs) to generate the LO signal; specifically, these VCOs take a control voltage as input to determine the frequency of output LO signal. As VCOs operate under high non-linearity and produce unwanted emissions, they cause frequency fluctuations (harmonics and phase noise) of the output signal that blur the output IF signal when used in down-conversion and degrade its Signal-to-Noise Ratio (SNR). An experiment to validate this effect showed, for instance, that a VCO oscillator (with −69 dBc/Hz phase noise at 1 kHz offset frequency) used to down-convert from 5 GHz to UHF band can degrade the SNR value of the output IF signal by 5 dB; having two of these VCOs, one in the transmit chain and another in receive chain, can reduce the overall SNR level of the system by 10 dB.

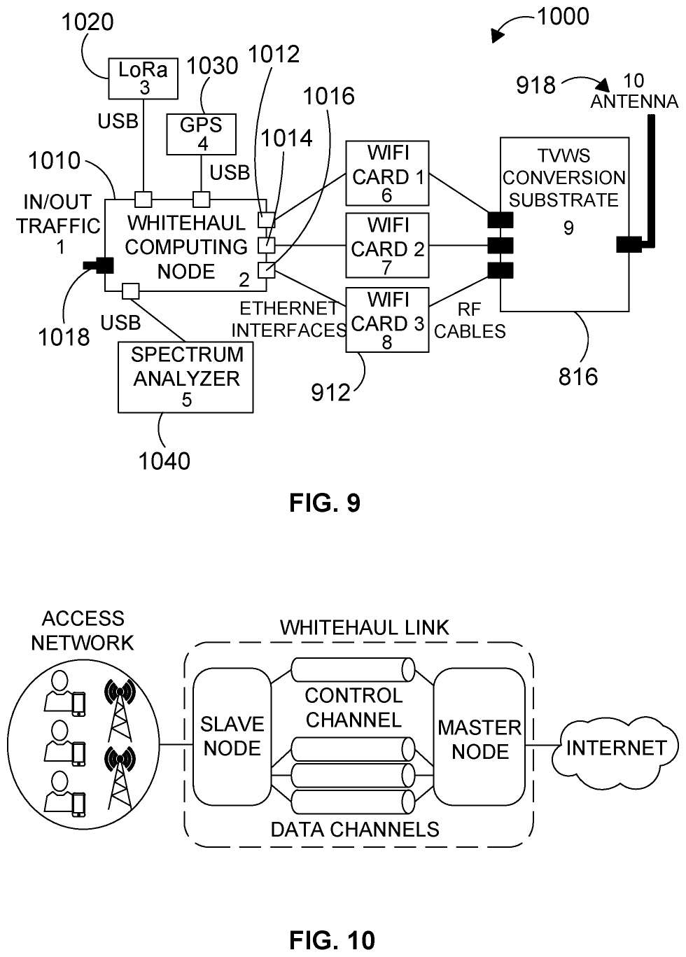

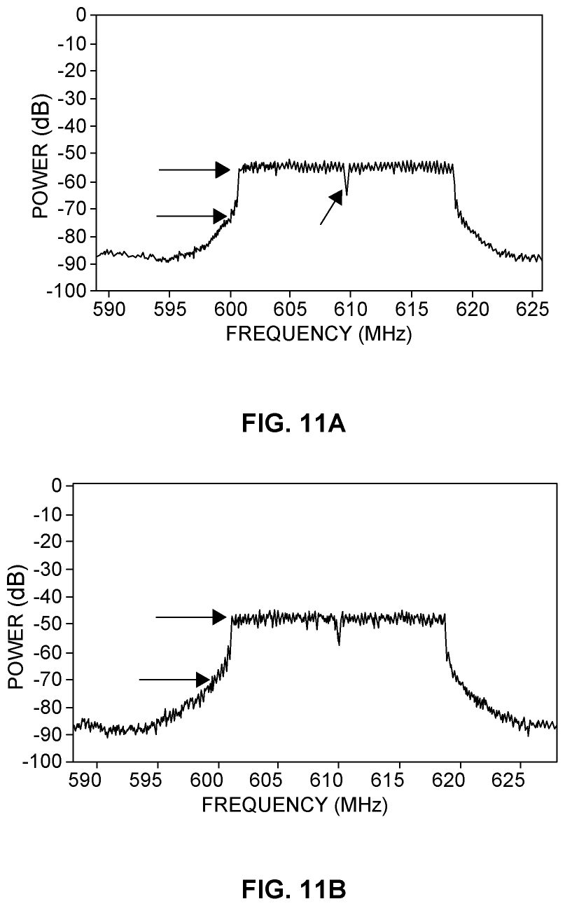

So as to avoid such degradation, the present embodiment takes a different approach and uses a SDR board (specifically USRP B210) to generate a sinusoidal signal without any distortion or phase noise. This approach not only results in a higher-SNR signal compared to VCO oscillators by 4 dB (as illustrated in FIG. 9) but it also provides high flexibility in (re-)configuring the center frequency of the generated signal by the Interface Configuration Module 942. The VCO lacks such flexibility due to the low granularity of the tuner voltage (steps of 0.25V which maps to steps of 20 MHz in the generated LO signal). FIGS. 11A and 11B shows (diagonal arrow) where the down-converted signal is not in the accurate 610 MHz central frequency. The SDR-generated LO signal can then be fed to the mixers 926, 936 to generate the up/down converted signal.

Separate Transmit and Receive Paths.

The present embodiment is also distinct from prior work in that it uses two separate transmit and receive paths (the TX and RX sub-channels), which allows for fine-grained configuration for RF components in each path for optimization of transmit signal quality (i.e., in terms of SNR) or receive sensitivity. To realize this separation, first and second fast Single Pole Double Throw (SPDT) RF switches 914 and 915 are used with 35 ns switching time, the first interfacing with the 802.11 card 912 and the second before the combiner/splitter 920 and UHF antenna 918. These switches 914, 915 have a wide bandwidth range from 500 to 6000 MHz, allowing operation in both 5 GHz and UHF bands.

The transmit path (TX sub-channel) includes the first configurable RF attenuator 922 to start with and then the first RF (high-pass) filter 924 to cut out spurious emissions from the 802.11 interface. Next is the highly linear down-conversion TX mixer 926 that supports wide range of frequencies from 3700 to 7000 MHz and is driven by the SDR based LO 916 described above. The resulting IF signal goes through the first low pass filter 928 to remove mixer related non-linearities. Then the low noise power amplifier (PA) 930, capable of 27 dBm output power and with a low noise figure of 1.2 dB, is used. This may be a voltage-controlled amplifier which can be adjusted (by changing the voltage level) to stay within the allowed transmit power. The amplified signal so generated is then fed to the combiner/splitter 920 through the second RF switch 915.

The receive path (RX sub-channel) includes the second low-pass filter 932 to start with to eliminate unwanted signals before going through the low noise amplifier (LNA) 934, which in this prototype embodiment has a high gain of 22.5 dB, an ultra low noise figure of 0.5 dB and a wide operational bandwidth range from 50 to 3000 MHz. The up-conversion RX mixer 936 translates the received UHF signal into the 5 GHz band with help of the LO 916, as above. It is preferable to use a single LO 916 for the pair of transmit and receive paths to make sure that the center frequency of the up-converted signal is the same as that of the RF signal down-converted in the transmit path. Following the RX mixer 936, the second RF (high pass) filter is included to remove the unwanted signal from the mixer. Finally, the second configurable attenuator 940 is used to avoid saturating the receive chain on the 802.11 interface 912.

Combiner/Splitter.

To enable the use of a single antenna 918, while using multiple interfaces 912 to achieve a high capacity backhaul link, the RF power combiner/splitter 920 can combine different transmit paths (from the different 802.11 interfaces 912) into one output that is fed to the antenna 920 or split the received UHF signal into multiple receive paths. The present embodiment may use a combiner/splitter 920 with high isolation (25 dB typical) to prevent leakage between paths. Moreover, it can handle high transmit power up to 10 W (aggregated), and has five input ports (for combining up five 5 different 802.11 cards 912) with a total bandwidth of 320 MHz that can span the whole TV band.

The embodiment of the conversion substrate described above uses separate TX and RX sub-channels (paths) for each TX/RX channel. An alternative implementation can use a single path for both TX and RX.

While the embodiment illustrated in FIG. 8 employs a separate TX sub-channel and RX sub-channel for each TX/RX channel, the system could be implemented using a single channel for the TX/RX channel, since each of the RF components in the WhiteHaul conversion substrate is bidirectional. Such an implementation provides cost savings as compared with the use of two sub-channels (by reducing the number of physical components required, as discussed further below), but also has disadvantages compared with the use of two sub-channels.

Where only one path (channel) is used for both TX/RX, each TX/RX path may consist of six main RF components including, attenuator, high-pass (RF) filter, RF mixer, low-pass filter, amplifier, and SDR-based oscillator, corresponding to the components 922, 924, 926, 928, 930 and 916 of the TX sub-channel of FIG. 8, plus a power combiner/splitter corresponding to the combiner/splitter 920 of FIG. 8. The main contributor to the total cost is the SDR-based LO (e.g., LimeSDR [6]). Second is the cost of active RF components such as the amplifiers and RF mixers. Next is the cost of the power combiner/splitter, which is capable of combining four chunks of the spectrum. All other remaining passive components have minimal costs. The wireless 802.11n/ac cards cost is relatively small. However, there are drawbacks to using a single TX/RX path, as discussed below, and the cost grows non-linearly when two separate TX/RX paths are used due to the fact that only one SDR-based LO is used for both paths.

Similarly to the TX sub-channels of FIG. 8, each single TX/RX path has a configurable RF attenuator to start with followed by a high-pass filter to cut out spurious emissions from the 802.11 interface. Next is a highly linear downconversion mixer that supports a wide range of frequencies from 3700 to 7000 MHz and is driven by the SDR based LO as described above. The resulting IF signal goes through a low pass filter to remove mixer related non-linearities. Then a low noise power amplifier (PA), capable of 27 dBm output power and with a low noise figure of 1.2 dB, is used. This is a voltage-controlled amplifier which can be adjusted (by changing the voltage level) to stay within the allowed transmit power. The amplified signal is then fed to a combiner/splitter.

When a signal is received at the antenna, it is split by the combiner/splitter component to different cards and reversely traverses the same path to upconvert the TVWS signal to a Wi-Fi signal to be received by the Wi-Fi cards. Leveraging a single TX/RX path can reduce the cost and complexity of TVWS conversion substrate as discussed above, however, it limits the flexibility of the WhiteHaul system significantly. In the single TX/RX path, the received signal will not be amplified because the power amplifier (PA) is a unidirectional component that can only amplify the transmit signal. Therefore, if the received signal was not strong enough, it will reach the Wi-Fi card (after the upconversion process) with low quality, which affects the overall performance. Adding a second amplifier such that the TX/RX path includes two amplifiers in a reverse order, one used for the transmitted signal and another one used for the received signal, can solve the problem. However, this is not enough to provide full flexibility (as in the case of using separate TX and RX sub-channels), which requires different attenuation configurations for both the transmitted and received signals, and that cannot be realized using two attenuators (with different configurations) on the same path.

4.1.2 Coordination and Synchronization

The control interface 818 enables the coordination between the Master and Slave ends of a WhiteHaul PtP link, which is useful for two purposes. First, for the Slave node to notify the Master about the TVWS spectrum availability/sensing information at its location as well as its traffic demand every epoch (30 seconds in this example). Second, for the Master to notify the Slave about the set of TVWS spectrum chunks to use for its interfaces as well as the time slot duration in the reverse direction. In this implementation, control communication is realized using low-cost Pycom LoRa gateways [7] that operate on very narrow channels (7.8-500 KHz) in 868 MHz spectrum band and are capable of achieving few tens of Kbps data rate over long distances, up to 40 Km. Along with a control interface, each WhiteHaul node is also equipped with a GPS receiver to facilitate localization and time synchronization, the latter for TDD operation.

4.2 Software Layer

4.2.1 Interface Configuration

The interface configuration module 942 is responsible for the configuration of interfaces 814/912 at WhiteHaul link endpoints with spectrum chunks via coordination over the control interface 818. As a basic step, both the Master and Slave each periodically checks with the geolocation database (as obligated by the regulator) about TVWS spectrum availability and allowed power levels at their respective locations. In addition, each WhiteHaul node is preferably equipped with a low cost spectrum analyzer (RF Explorer [9] in this implementation) to estimate the interference in available TVWS channels. This is motivated by the interference related observation made in Section 2 above and recent work (e.g., [35]) that observes that aggregate interference from multiple nearby transmitters can impact the quality of available channels. So, using the spectrum analyzer, each node sweeps the whole TV band periodically to obtain the signal level on all the available TVWS channels as an estimate of interference on those channels. The Slave then syncs all its information for the above with the Master end.

The Master then estimates the signal-to-interference-plus-noise ratio (SINR) for each of the TVWS channels commonly available between the endpoints and in both forward and reverse directions. For this, it uses the spectrum availability and sensing (interference) information obtained as above. Additionally, it estimates the received signal power on the common channels at the two nodes. For this received power calculation, the SPLAT! RF planning tool [38] can be used to estimate the path loss in each direction along with transmit power and antenna gains. Based on the above, the link SINR for each channel is estimated as the lower of the two values for forward and reverse directions. With the channel-level SINR for the link in hand, the question is to decide on the TVWS spectrum chunks for the node interfaces. This may start with identifying the potential spectrum chunks considering contiguous sets of available channels on both ends. Then, keeping in mind the number of interfaces available, a subset of chunks (with center frequencies and chunk sizes to match with 802.11ac channel widths) are selected from all possibilities with the aim of maximizing the average SINR for each chunk. This may result in picking smaller sized chunks (with higher SINR yielding TVWS channels) instead of larger chunks with lower average SINR, thereby addressing the power asymmetry effect highlighted in Section 2. Note that the power level chosen for a chunk is limited by the lowest power allowed among the constituent TVWS channels. Moreover, the modulation and coding scheme (MCS) may be automatically adapted by the 802.11 interfaces via the default built-in mechanism. Also note that the above procedure constrains to using only the available TVWS channels as prescribed by the geolocation database and at the stipulated power levels.

4.2.2 Slot Allocation

As noted earlier, the WhiteHaul links are designed to operate in TDD mode. This not only provides more flexibility and control for traffic scheduling across interfaces via easing capacity estimation, as elaborated in the next subsection, but also is essential given the choice to use to low-cost COTS 802.11 cards based on Carrier-sense multiple access (CSMA). Concerning the latter, the root of the issue is that in 802.11 each node senses the spectrum for a certain time period given by Distributed Inter Frame Space (DIFS) (34 us) before attempting to transmit. When the link distance is longer than 10.2 Km, one end of the link cannot hear the other within this period, which then leads to collisions from potential simultaneous transmissions by both ends. Indeed, this observation has motivated the shift to using time division multiplexing (TDM) based MAC protocols in the literature for long-distance wireless communications such as for backhaul (e.g., [56]).

While the preferred TVWS conversion substrate with separate transmit and receive paths allows for fast switching between the transmit and receive modes (35 ns), the key issue with TDD is deciding on the time slot duration for each direction (forward/reverse). The long-distance Wi-Fi literature (e.g., [56, 21, 55]) has taken the simplest approach to this issue by using static equal time share in both directions but this is not an efficient approach for backhaul and TVWS settings. First, as shown earlier in Section 2, backhaul traffic can be highly asymmetric, with more traffic in the downstream (access network) direction, and also varies over time. Second, with TVWS spectrum, power asymmetry and interference effects may result in different effective capacities between forward and reverse directions, suggesting an unequal time split to counter these effects.

In view of the above, a dynamic time slot duration selection for forward and reverse link directions is preferred, driven by traffic demand and effective capacities (obtained via the Interface Configuration module 942). Specifically, time is viewed as a sequence of small time units (20 ms in this implementation as per [56] to avoid undesirable TCP effects). Within each such time unit, the time slot duration is decided for forward and reverse directions. In fact, the time slot durations are adapted at a coarser time granularity of epochs (30 seconds in this implementation) to match with traffic variability. Note that effective capacities in this setting vary less frequently than the traffic. Also, the decision on the time slots is made by the Master based on locally available information and that obtained from the Slave 712 over the control interface.

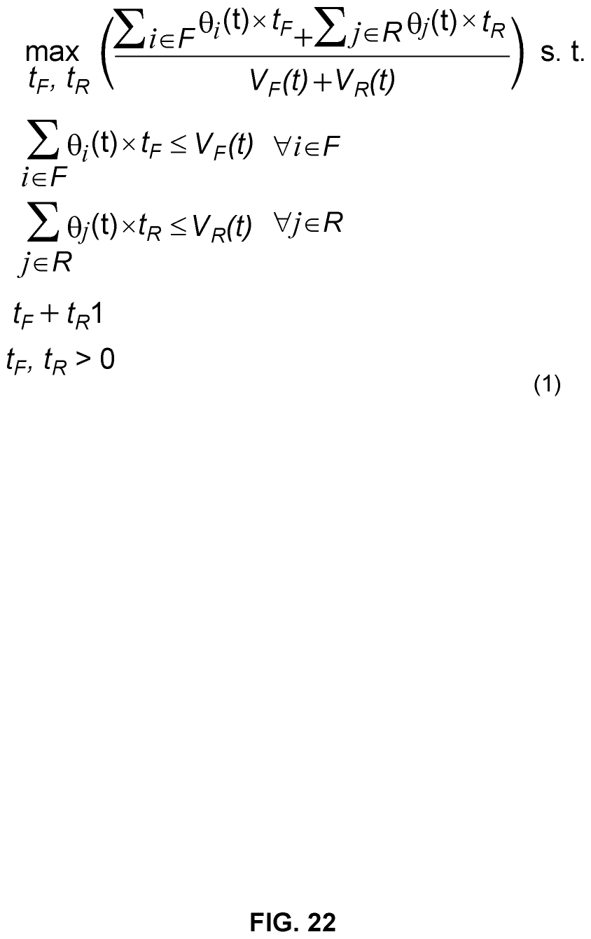

The key idea behind this approach is to choose forward and reverse time slot durations (equivalently, fractions within a time unit) so that they minimize the total backlogged traffic in both directions. As shown in FIG. 22; More precisely, at the start of each epoch t, the Master 710 θsolves the following optimization problem:

Where θᵢ(t) is the effective capacity of interface i at the start of epoch t. t_{F} and t_{R} are, respectively, the fractions of time within a 20 ms time unit allocated for the forward (Master-Slave) and reverse (Slave-Master) directions. V_{F}(t) and V_{R}(t) are, respectively, traffic volumes in forward and reverse directions for the upcoming epoch t. Each of these traffic volumes are the sum of forecasted traffic demand in the coming epoch t and backlogged traffic carrying over from the previous epoch. We consider a simple forecasting approach of assuming that the demand in the coming epoch will be same as the actual demand in the previous epoch, which is justified from the results in Section 2 for small epoch durations (30 seconds in this case).

4.2.3 Traffic Scheduling

The TVWS conversion substrate in the WhiteHaul hardware layer described above provides the physical capability to aggregate TVWS spectrum across multiple spectrum chunks over different interfaces. Translating this capability to higher layer aggregated data rates requires a way to concurrently use multiple interfaces and distribute backhaul traffic among them. The present embodiment seeks to realize this aggregation in a transparent manner to end-user traffic so as to give the abstraction of a high-speed link-level tunnel through which user traffic is transported across. Multipath TCP (MPTCP) is selected for this use case to meet the above mentioned requirements. Moreover, it offers a reliable bit pipe like TCP while also handling packet reordering from striping user traffic across multiple interfaces. It also automatically adapts to any configuration changes that alter underlying sub-link capacities.

However, the default MPTCP, which employs a coupled congestion control algorithm (e.g., LIA [32], OLIA [42]) whose main focus is on shifting traffic from congested to less congested paths to preserve network fairness among competing TCP flows, is not suitable for present purposes. The WhiteHaul system described herein has a single logical bidirectional flow that needs to efficiently utilize the underlying sub-link capacities to maximize aggregate link data rates in both directions. Even the uncoupled variant of the default MPTCP congestion control, with the commonly used CUBIC congestion control algorithm [29], fails to quickly and accurately track the changes in sub-link capacities (e.g., due to time slot adaptations) and/or losses, as is demonstrated in the evaluation results in the next section.

Motivated by the above, the present invention proposes a new cross-layer and uncoupled congestion control algorithm that is tailored for MPTCP use in WhiteHaul. It leverages information from the Slot Allocation Manager to dynamically adjust the congestion window (cwnd) size of each individual subflow (i.e. each of the data channels established for each white space spectrum chunk, each of which is bound to a different interface/spectrum chunk) according to its current effective capacity. This allows WhiteHaul MPTCP to fully utilize the available capacity of each subflow even as it varies over time. At the start of each epoch (i.e. at the start of each of a succession of predetermined time periods), the Slot Allocation Manager sends an advisory signal to the MPTCP congestion control module indicating the estimated capacity of each subflow. MPTCP then calculates a target cwnd value for each subflow by multiplying the advertised capacity and minimum round-trip-time (RTT) estimate it holds. WhiteHaul then increases cwnd rapidly and largely (100 packets per RTT) until it reaches the target value. Thereafter, WhiteHaul keeps increasing cwnd linearly (one packet per RTT) while monitoring the queuing delay. When the queuing delay exceeds a certain delay budget, cwnd is reduced back to the target value. In this way, WhiteHaul prevents self-inflicted packet losses by controlling the queue occupancy of network interfaces. Additionally, even when a packet is dropped for any reason (e.g. low SINR or buffer overflow) WhiteHaul is designed to quickly return back to its target, ensuring that the subflow capacity is fully used.

Multipath TCP (MPTCP) is a transport layer protocol that aims at allowing a computing device to utilize multiple paths in order to maximize the available resources. The MPTCP has one shared send queue where all the data coming from the application layer is centrally stored in that shared queue. There are two main components for data scheduling in MPTCP implementation, which are (i) packet scheduler, and (ii) congestion controller. The main function of the packet scheduler is to identify which of the available subflows to feed with packets from the shared send queue. On the other hand, the congestion controller identifies how much data (how many packets) the scheduler should put on each subflow. The number of packets that can be put on each subflow is defined by the subflow's congestion window (cnwd). The congestion window of a subflow is estimated as a function of the available capacity of the physical interface associated with that subflow, and the time each packet takes to travel through that interface to reach the receiver. For example, suppose a computing device is connected to a server, through two interfaces, Interface1 with capacity of 10 Mbps and Interface2 with capacity 5 Mbps. The latency (e.g., round trip time) is 10 ms and 30 ms for interface1 and interface2, respectively. Given that, the number of packets that can be assigned to subflow1 is (Capacity×RTT)/(Packet size)≅8 packets and to the subflow2 is ≅12 packets.

When an MPTCP connection is initiated, two level sockets are created by the application: meta-socket and master subsocket. The meta-socket acts as the connection level socket, and holds the shared send queue, connection-level receive queue and out-of-order queue that is used for reordering purposes. The master subsocket is the first socket used when the MPTCP connection is initiated, and in case of having only one subflow. When any additional subflow is created by MPTCP session, a new slave subsocket is created; however, unlike the master subsocket, these additional slave subsockets are not visible to the application layer. Each of these slave subsockets, in addition to the master subsocket, have a send queue, where at the transmission time, the packet scheduler pulls a packet from the shared send queue in the meta socket, and puts it on the queue of the available subfiow (i.e. a subflow having some space in its congestion window).

The function of the present congestion control algorithm is to estimate the congestion window size of each subflow. As aforementioned, the congestion window size is a function of different parameters that change dynamically over time, including the channel quality (i.e., interference level), the time-slot allocation, the size of the spectrum associated with that interface, and the operational parameters (e.g., transmit power). The default congestion control algorithm for MPTCP (i.e., CUBIC) fails to handle the dynamic environment of backhauling links. Incorrect estimation of the congestion window leads to severe performance degradation of the system performance either by increasing the queuing delay, by pushing more data packets than that the physical interface can handle, or by underutilizing the available capacity. Therefore, one aspect of the present invention provides a new MPTCP cross layer congestion control that leverages information for the underlying MAC layer to accurately estimate the congestion window and efficiently utilize the available resources.

Algorithm 1 in FIG. 21 highlights the key part of the algorithm implemented in a Linux Kernel.

In short, when a new Acknowledgement packet (ACK) is received on subflowᵢ, which begins a new window of data, the average queuing delay (aqd) is computed (lines 2-3). The queuing delay is the amount of time that the packet can wait in the queue until it gets transmitted. For each queue, there is a queuing budget (λᵢ) metric which is how much the congestion control algorithm tolerates queuing delay on that interface (subflow). For example, if the queuing budget is set to 30 milliseconds, it means that the algorithm will not allow the queuing delay to grow beyond that number. In other words, the purpose of the queuing budget is to limit the queuing delay under some value.

The target size of the congestion window (cwndᵢ) of interface (i) is (Ωᵢ), i.e. the accurate congestion window size estimation, computed by consulting the underlying MAC layer. The algorithm calculates the weight factor (αᵢ), which dictates the increase rate of cwndᵢ, as seen in (lines 4-10). The value of (αᵢ) becomes large when cwndᵢ is lower than the target window (Ωi) and also when the average queuing delay is smaller than the queuing budget (λᵢ), ensuring that during the congestion avoidance phase (lines 14-15) cwndᵢ is increased aggressively until it reaches (Ωᵢ). When cwnd, is less than the target window (Ωᵢ) and the average queuing delay is smaller than the queuing budget (λᵢ), it means that the number of packets that the MPTCP puts on that interface has not reached the target window yet, thus, the algorithm should aggressively increase cwnd, to allow more packets to flow through that subflow until the number of packets reaches the target window size.

Otherwise if cwndᵢ reached the target window (Ωᵢ), then cwndᵢ is increased linearly (similar to standard TCP). At the beginning of every window of data, the present algorithm examines whether it is allowed to reset cwndᵢ to Ωᵢ (lines 11-13), making sure that the queue occupancy of the underlying wireless interface of subflow (i) is not exceeding a certain threshold. Finally, when a lost packet is detected on a subflow, by receiving at least three duplicate ACKs, WhiteHaul reduces cwnd, very gently (lines 18-19).

In other words, when a new ACK is received on subflow (i), which begins a new window of data, the average queuing delay (aqd) is computed (line 2-3). Thereafter, the weight factor (αᵢ), which dictates the increase rate of cwndᵢ. is updated (lines 4-10). The value of a, becomes large when cwndᵢ is smaller than the target window (Ωᵢ), ensuring that during the congestion avoidance phase (lines 16-17) cwnd, is increased aggressively until it reaches Ωᵢ. Otherwise it becomes small in which cwnd, is increased linearly (similar to standard TCP). At the beginning of every window of data, the algorithm examines whether it is allowed to reset cwndᵢ to Qᵢ (lines-11-14), making sure that the queue occupancy of underlying wireless interface of subflow (i) is not exceeding a certain threshold. Finally, when a lost packet is detected on a subflow, by receiving at least three duplicate ACKs, the algorithm reduces cwnd, very gently (lines-21-22).

4.2.4 WhiteHaul Nodes in Use

FIG. 9 shows the main hardware components of an example of a single WhiteHaul endpoint 1000 and the interconnections of those components.

The endpoint 1000 includes a TVWS conversion substrate 816, in this case providing three data channels, three WiFi cards 912, one for each data channel, and an antenna 918, as previously described, a computing node 1010, a LoRa module 1020, a GPS module 1030 and a spectrum analyzer 1040. The functions of the LoRa module 1020, GPS module 1030 and spectrum analyzer 1040 are described above; i.e. the LoRa and GPS modules together provide the control interface and GPS receiver 818, and the spectrum analyzer sweeps the whole TV band periodically to obtain the signal level on all the available TVWS channels as an estimate of interference on those channels.

The computing node 1010 executes the software layer as illustrated in FIG. 7. As previously described, the software layer includes different modules such as the traffic management module 822, interface configuration module 942, and coordination module 820. In this example, the computing node 1010 has four Gigabit Ethernet (GbE) interfaces/ports 1012, 1014, 1016 and 1018, three of which, 1012, 1014 and 1016, are used to connect the computing node 1010 to the three different WiFi cards (i.e., the 802.11ac cards) corresponding to the data interfaces 912 of FIG. 8. The fourth GbE interface 1018 provides an input/output port used for the incoming and outgoing traffic that goes through the WhiteHaul link via the endpoint 1000. For example, when a user tries to upload a file to a server via the WhiteHaul link, the uplink traffic goes inside the WhiteHaul computing node 1010 through that interface 1018, and the MPTCP scheduler 826 of the traffic management module 822 distributes it among the different WiFi cards 912 based on the capacity and the link characteristics of each interface. Then, the Wi-Fi signals generated from the three cards 912 are down-converted to the TVWS band by the TVWS conversion substrate 816) and sent to the antenna 918. Download traffic experiences the reverse operation.

The connections from the Wi-Fi cards 912 to the TVWS conversion substrate 816 may be realized using RF cables for SMA connectors and SMA to Type-N converters. RF cables may also be used between the output of the conversion substrate 816 and the antenna 918. A conventional UHF yagi antenna may be used, however a dual polarization antenna can be used as well. Other hardware components like the LoRa module 1020 that is used for the coordination purposes between two end-points, spectrum analyzer 1040 and the GPS module 1030 may be connected to the computing node through USB ports. Each of these hardware components is controlled by the different modules of the software layer implemented in the computing node 1010.

The endpoint 1000 may be used as a master node 710 or slave node 712 of a WhitHaul link as illustrated in FIG. 6. Pairs of endpoints 1000 may be connected back-to-back via their input/output ports 1018 to provide one or more WhiteHaul relays within a WhiteHaul link between a master node endpoint 710 and a slave node endpoint 712. The two sides of the relay pair may use different spectrum chunks at any given time, selected to suit the WhiteHaul endpoints with which they communicate via their antennas 918.

FIG. 10 illustrates how two endpoints of a WhiteHaul system enable Internet access to users in remote areas.

1. The users in rural or remote communities use their mobile phones to access the conventional Wi-Fi Access Points (AP) or cellular base stations. Either commercial base stations or open-source platforms can be leveraged to enable cellular network access.

2. The WhiteHaul slave node is the gateway device for the access network in the rural community.

3. The Wi-Fi AP or the cellular base stations are connected to a gateway router. Each AP has a dedicated ethernet port on the router, the WhiteHaul slave node is also connected to that router. The router is configured to forward any packet with external destination IP address to the WhiteHaul slave node's port.

4. The end-user devices do not have direct interaction with WhiteHaul nodes (both the slave and the master nodes). They only access the AP (as illustrated in the figure), and these access points are responsible to forward the user's traffic to the gateway router which then forwards it to the WhiteHaul slave node.

5. In the setup phase, both WhiteHaul nodes are configured to use N number of data channels (e.g., one, two or three, etc) and only one control channel. These data channels are realized using Wi-Fi cards (specifically, 802.11ac), and down-converted to the TV band. However, the Wi-Fi cards are not visible neither to the end-user devices in the rural community, nor to any end devices on the Internet (e.g., servers). The Wi-Fi cards are only visible within the WhiteHaul link. The WhiteHaul link is the data communication link between the whitehaul master and slave nodes.

6. Upon receiving the traffic from the gateway router, Whitehaul slave node passes it to the traffic management module. The traffic management module is a MPTCP congestion control and scheduling algorithm that decides on which data channel should the received traffic be forwarded?

7. This traffic scheduling decision is based on two factors. First, the latency that a packet would experience on each interface (i.e., each data channel is associated to one physical interface). Second, the available capacity of each interface. The available capacity of each interface is a function of several components, including, the channel quality (i.e., interference level), the time-slot allocation, the size of the spectrum associated with that interface, and the operational parameters (e.g., transmit power).

8. The default MPTCP scheduler puts the received packets on the interface that has the minimum latency (among all available interfaces) until all available capacity on that interface is consumed. The scheduler then moves to the next interface which experiences the second minimum latency, and so on.

9. Estimating the available capacity on each interface is the responsibility of MPTCP congestion control. Capacity estimation is a challenging task because of the different factors we mentioned above. Thus, the default MPTCP capacity estimation (congestion control algorithm) fails to handle such a dynamic network environment of the backhauling link. A wrong estimation of the available capacity of each interface can lead to underutilizing the backhauling link resources and limiting its performance.

10. To tackle that, we propose a new cross-layer congestion control algorithm that estimates the available capacity on each interface, accurately, by consulting the underlying layers (i.e., MAC layer).

11. Once the traffic management module decides on which interface to forward the packet, it arrives to the Wi-Fi cards (from the computing node, see FIG. 9) over ethernet interface. The Wi-Fi signals coming from different cards are then down-converted to the TV band signals and combined to be emitted on a single antenna in the TVWS conversion substrate.

12. The whitehaul master node receives the TVWS signal, splits and up-converts it to Wi-Fi signals which can be received by the Wi-Fi cards that exist in the whitehaul master node. The Wi-Fi cards forward the traffic to the computing node which in turn forward to the In/Out ethernet interface (see FIG. 9) that is connected to the Internet.

13. The same process is repeated when the traffic comes from the Internet to the end-user devices in the remote/rural communities.

Evaluation

This section evaluates three key aspects of WhiteHaul. First, we benchmark spectrum aggregation and conversion efficiency with WhiteHaul relative to the ideal case using our prototype implementation. Second, we use simulations driven by real-world traffic trace presented in Section 2 to assess the benefit of dynamic time slot allocation in WhiteHaul in comparison with the static half-split allocation approach. Third, using our Linux kernel implementation of WhiteHaul MPTCP, we experimentally evaluate the throughput obtained with its congestion control with respect to both commonly used OLIA (coupled) and CUBIC (uncoupled) congestion control algorithms.

5.1 Spectrum Conversion and Aggregation Efficiency

Here we study aggregate TCP throughput obtained with WhiteHaul in all possible two and three interface combinations of 802.11ac channel widths supported by our interface cards (20, 40 and 80 MHz). The flexibility with WhiteHaul allows us to down-convert any 5 GHz channel to TV band by appropriately configuring frequency of the SDR based LO. We use unoccupied 5 GHz Wi-Fi spectrum in our environment in the range of 5500-5750 MHz. We use our implementation of WhiteHaul as described in the previous section including its MPTCP Linux kernel implementation. Unidirectional TCP traffic with iPerf tool is used.

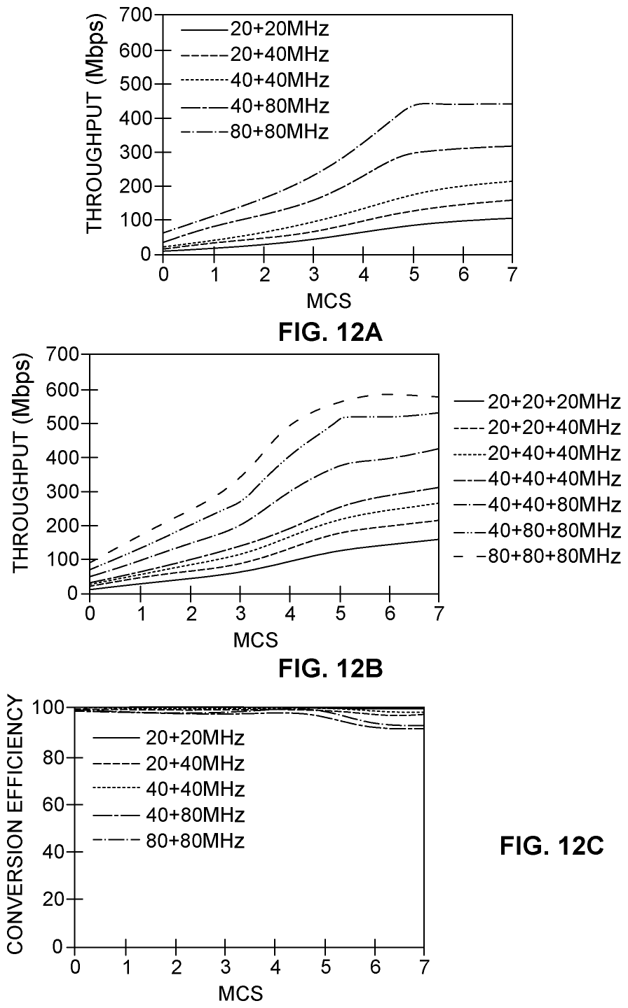

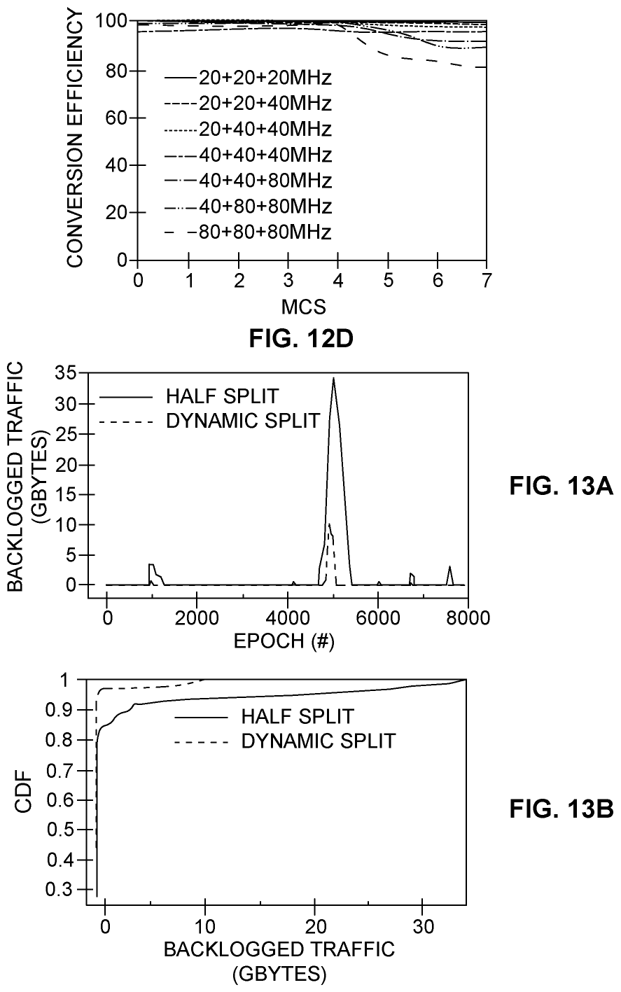

In each of the two and three interface scenarios, MPTCP throughput achieved with WhiteHaul after down conversion and aggregation is reported. In effect, each interface ends up using a TVWS spectrum chunk of the specified width. We benchmark these results against the best case overall throughput, which is computed as the sum of maximum TCP throughputs achievable per interface for a given channel width and MCS in 5 GHz band without any frequency conversion or aggregation. FIGS. 12 (a) and (b), respectively, show the throughput results with WhiteHaul for two and three interface scenarios. The corresponding throughputs as a percentage of the best case overall throughput, referred to as “Conversion Efficiency”, are shown in FIGS. 12 (c) and (d). We see that WhiteHaul can provide maximum throughput up to 446 Mbps when using two 80 MHz channels. And with three interfaces using three 80 MHz channels packed together with little channel spacing (aggregation of 240 MHz spectrum), it provides up to 590 Mbps aggregated throughput; and up to 640 Mbps with adequate channel separation (not shown here). We also observe that in all combinations of 20 and 40 MHz channels, WhiteHaul TVWS conversion substrate and aggregation technique achieves 99% efficiency across all MCS values. This is because of almost perfect down-conversion without any signal distortion. When using even wider 80 MHz channels with reduced inter-channel spacing, however, higher adjacent channel leakage lowers the efficiency. For low MCS values (up to MCS5), WhiteHaul is still able to achieve close to best performance with average efficiency of 98% (as shown in 80 MHz scenarios of FIGS. 13 (b) and (d)). But the average efficiency drops down to 89% for higher MCS values (MCS6 and MCS7) and to the lowest level of 80% in the case of 3 adjacent 80 MHz channels.

5.2 Slot Allocation

Here we evaluate the dynamic time slot allocation between forward and reverse directions in WhiteHaul in comparison with static, equal time split baseline. We use the total backlogged traffic carried forward from epoch to epoch as a performance measure. This evaluation is based on Monte Carlo simulations using MATLAB and with parameters as listed in Table 1 below. Effective link capacities are randomly generated within the range shown in Table 1 but traffic volumes in forward and reverse directions are from the real-world network trace as described in Section 2. The epoch length is set to 30 s, also based on traffic characteristics analysis in Section 2.

TABLE 1
Simulation Parameters

| Parameter | Value |
|---|---|
| Number of iterations | 1000 |
| Number of epochs | 7877 |
| Epoch duration (secs) | 30 |
| Effective capacity (Mbps) | [5, 60] |
| Number of interfaces | 2 |

As described in Section 4.2.2, WhiteHaul dynamically decides on slot allocation within each time unit for the upcoming epoch at the start of it based on forecasted traffic volumes and effective capacities in each direction. FIG. 13A shows the improvement with this approach compared to static, half-split in terms of amount of backlogged traffic per epoch for a one week period. We observe that WhiteHaul significantly reduces the total backlogged traffic from awareness and adaptation to asymmetric traffic characteristics. The CDFs in FIG. 13B show that in almost 87% of the time for the one week period, the dynamic allocation does not have any backlogged traffic in either direction. In contrast, this number is only around 60% for half-split. Moreover, the maximum backlogged traffic per epoch with the half-split case reaches up to 30 GB whereas it is only up to 7 GB with dynamic slot allocation.

The time allocation manager divide the collected traces into per minute volumes and uses the previous epoch volumes as a forecasting value for the traffic in the current epoch. FIG. 13A shows the amount of backlogged traffic per one time epoch for a period of one week. The figure shows how successfully the dynamic time allocation can be able to leverage the diversity of traffic distribution to accommodate high portion of time slot for the direction with higher traffic demand. That behaviour helps to reduce the total backlogged traffic compared to the static half-split which does not utilize the time slot because it perform symmetric slot allocation for asymmetric traffic. The CDF functions in FIG. 13B shows that in almost 87% of the time for the one week period, the dynamic allocation has no any backlogged traffic in both directions. On the other hand, only 60% of the time for the same period does not experience backlogged traffic. In addition, the amount of backlogged traffic in the half-split approach reaches up to 30 GBytes per one epoch while the maximum value of backlogged traffic in the dynamic allocation was 7 GBytes.

5.3 Traffic Scheduling

Here we experimentally assess the effectiveness of WhiteHaul MPTCP based aggregation in wide range of capacity and packet loss scenarios, relative to two MPTCP alternatives using coupled congestion control with OLIA [42] and uncoupled congestion control with CUBIC [29] algorithms. We approach this in two steps. We first characterize packet loss and effective capacity in different link quality conditions and with different channel widths. This characterization then is used as the basis for emulation based evaluation of WhiteHaul and other MPTCP alternatives.

5.3.1 Packet Loss and Capacity Characterization

Using wider channel bandwidths for high capacity TVWS backhaul links can potentially impact transmission range and cause higher susceptibility to interference due to distribution of the same power over a wider bandwidth [20]. These both manifest as increased packet loss rates, which can have adverse effect on most TCP based alternatives. We therefore conduct a controlled study to understand the nature of packet losses and effective capacities in a TVWS-based long distance setting. For this, we attenuate the transmitted TVWS signal using a combination of step attenuator and transmit power adjustment. The resulting received signal strength (RSS) values range from −80 dBm to −50 dBm, reflecting increasing link distances.

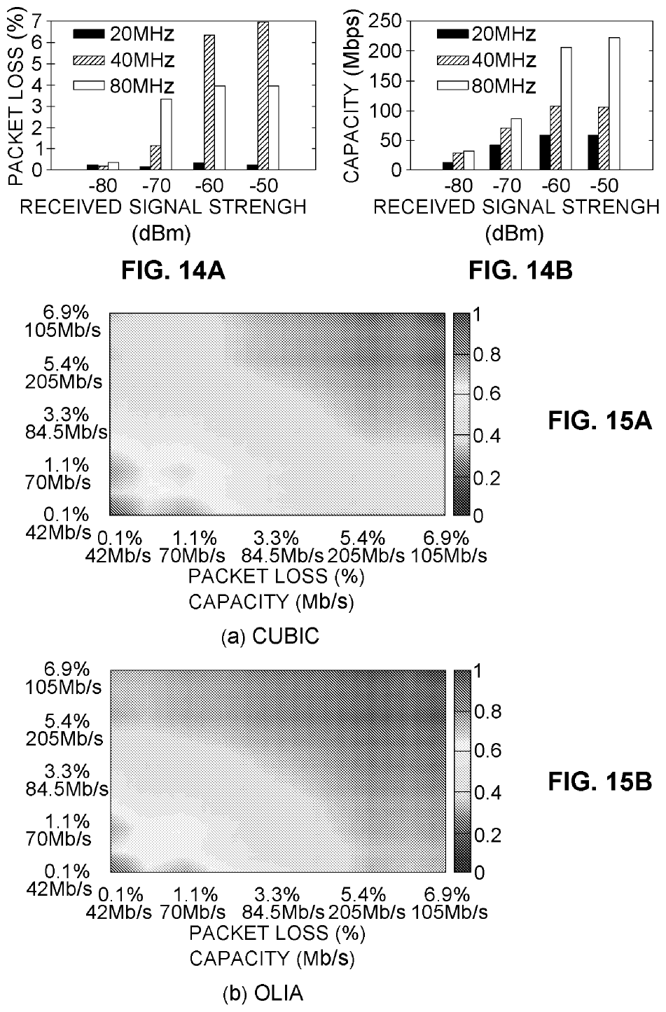

To measure the loss rate and effective capacity, we use Iperf with CBR UDP traffic streams and also experiment with three different channel widths (20, 40 and 80 MHz). As shown in FIG. 14A, on narrow channels, e.g., 20 MHz, the link has very low loss rate, almost negligible, and the maximum loss rate observed across different RSS values was 0.3%. At higher channel width, packet losses increase up to 6.9% (with 40 MHz channel). Packet loss differences between 40 MHz and 80 MHz channels are an artifact of the mechanics of underlying rate adaptation mechanism. On the other hand, the effective capacity, measured in terms of UDP throughput.

FIG. 14B is along expected lines—increasing with increasing RSS and channel width.

5.3.2 WhiteHaul MPTCP In Diverse Conditions

We use the results from the above study to evaluate WhiteHaul MPTCP performance in different conditions. We use our Linux kernel implementation for WhiteHaul and compare it with CUBIC [29] and OLIA [42]. The setup for this experiment consists of two Linux desktops, each with two Gigabit Ethernet interfaces. We use Linux Network Emulator (netem) and Traffic Control (tc) to emulate both losses and sub-link capacities from S.5.3.1. For WhiteHaul, we set the queuing delay budget (\lambda) as 50 ms. The target cwnd size is calculated according to the bandwidth-delay product (BDP). We use iPerf tool send uni-directional TCP traffic and measure the aggregate throughput across the two interfaces.

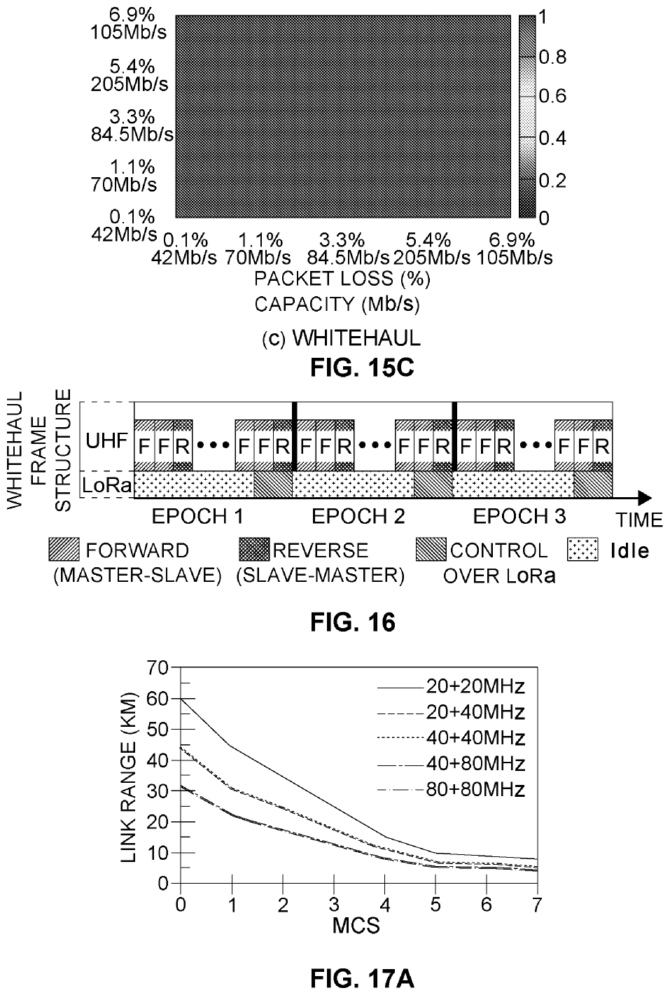

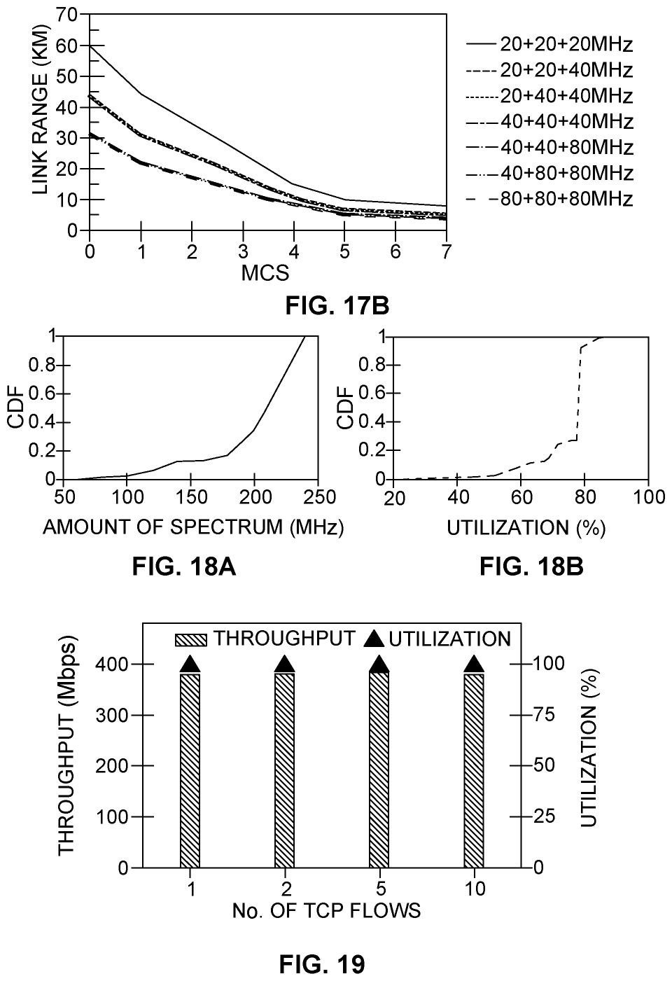

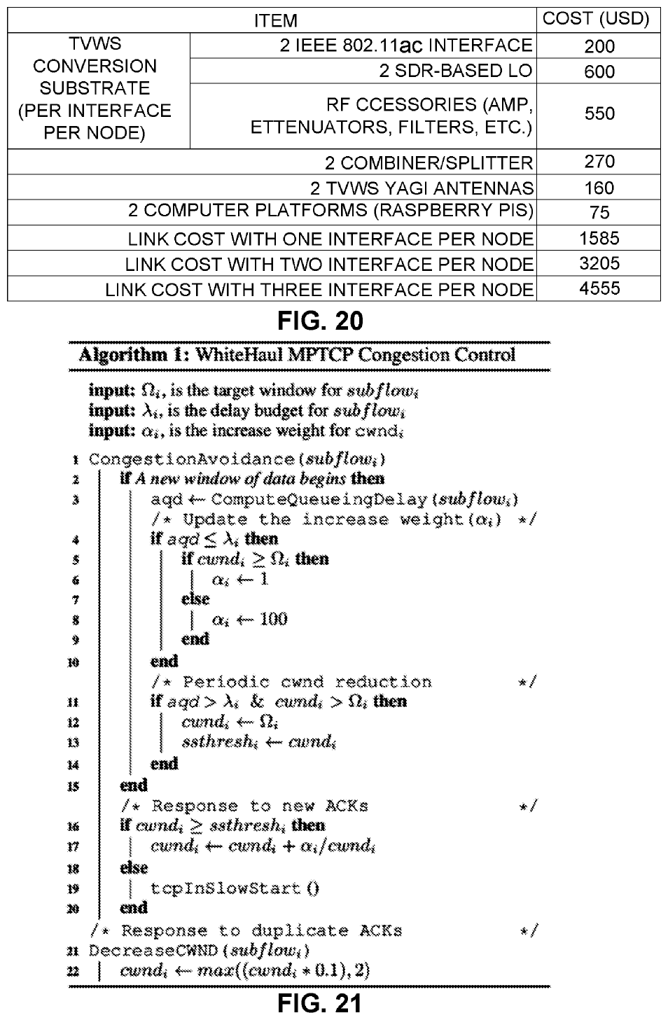

FIG. 15 shows the results for the three alternatives as heatmaps of efficiency, defined as the ratio of the achieved throughput to the overall best case throughput obtained with the same link capacities in the absence of losses. We observe that CUBIC in general performs better than OLIA in the presence of losses, which can be attributed to the fact that each sub-flow behaves independently and with separate congestion window in uncoupled MPTCP (the CUBIC case), therefore, the penalization (i.e., due to packet losses) of one sub-flow does not affect the congestion window of the other sub-flow (due to Coupled traffic shifting feature). Overall though, WhiteHaul algorithm clearly achieves superior performance, by an order of magnitude, compared to both CUBIC and OLIA. In some scenarios like in the upper right corner, WhiteHaul, CUBIC and OLIA achieve aggregate throughputs of 403.8 Mbps, 31.6 Mbps and 22.3 Mbps, respectively. The significant improvement of WhiteHaul algorithm is due to two reasons. First, the WhiteHaul congestion control algorithm is robust in presence of losses to maintain sending rate close to sub-link capacities whereas CUBIC and OLIA have drastic responses to lost packets. Second, WhiteHaul relies on the periodic advisory signal from the slot allocation manager to keep track of the optimal congestion window size and uses it to ramp up the rate instantly to that level and increases linearly while keep monitoring the queuing delay. If the queuing delay exceeds the delay budget, the congestion window shrinks back again to the target value, preventing self-inflicting losses due to RTOs.

### 6 RELATED WORK

6.1 Support for Spectrum Aggregation in Wireless Standards

The IEEE 802.11 wireless LAN (WLAN) standards have supported channel bonding (contiguous channel aggregation) since 2009 when 802.11n introduced 40 MHz bonded channels as a feature to provide high user/network data rates. This continued with the subsequent and current 802.11ac standard [15], which additionally mandates support of 80 MHz channels and operation exclusively in the 5 GHz band. 802.11ac also has optional support for contiguous 160 MHz or non-contiguous aggregation of two 80 MHz wide channels. Although the focus of 802.11 is on the WLAN setting involving communication between an AP and associated clients, equivalent to a point-to-multipoint (PtMP) scenario, and is largely limited to aggregation of contiguous spectrum, we leverage the 802.11 channel aggregation feature in the design of WhiteHaul towards a low-cost backhaul point-to-point (PtP) solution.

On the other hand, spectrum aggregation, or more precisely carrier aggregation (CA), has also been an integral part of 3GPP cellular network standards since 2011 (Release 10) when LTE-Advanced (LTE-A) was introduced [48, 63]. The essential idea behind the CA is to aggregate two or more component carriers (CCs) of different bandwidths (between 1.4 MHz and 20 MHz) up to 100 MHz with five CCs of 20 MHz. The CCs aggregated could be contiguous within a band, or non-contiguous (in the same or different bands), leading to three CA types: intra-band contiguous, intra-band non-contiguous and inter-band non-contiguous, the latter being the most complex. The CA is realized through a combination of advanced front-end hardware design and efficient cross-carrier scheduler, the former allowing multiple transceivers to transmit/receive on different carriers while minimizing the power leakage. The target usage scenario for CA is also PtMP and the focus in CA is mainly on how to select the CCs, possibly across sites (e.g., macro and small cells), and schedule resource blocks to user devices (UEs) across CCs. From our perspective, CA also limits the amount of spectrum that can aggregated to 100 MHz.

6.2 Higher Layer Aggregation Approaches

Besides the PHY/MAC layer spectrum aggregation techniques discussed above, higher layer aggregation techniques also exist, such as MPTCP at transport layer [30, 31], Multipath QUIC (MP-QUIC) [19, 68] at application/transport layer, and LTE-WiFi Aggregation (LWA) at LTE PDCP layer [12]. Different from the lower layer techniques, these approaches can be technology agnostic which allows more flexible aggregation not only between transceivers of the same technology but also across different technologies. In recent years, there have been several traffic scheduling algorithms proposed in this context targeting heterogeneous settings and considering the different characteristics (e.g., bandwidth, latency, etc.) [24, 28, 34, 44, 49, 47]. In contrast to the above works, our WhiteHaul system takes a hybrid aggregation approach combining the lower layer aggregation capability with a higher layer technique, the latter in our case realized using MPTCP variant with new tailored uncoupled congestion control algorithm.

6.3 TVWS Spectrum Aggregation

In IEEE 802.22 [18], the early TVWS standard targeting rural and remote areas, only a single (6/8 MHz) TVWS channel is used. In the more recent 802.11af standard framework that is aligned with regulatory requirements to use geolocation databases, aggregation up to 4 contiguous or non-contiguous TVWS channels is allowed [26]. The various commercial TVWS solutions that currently exist (some compliant with 802.11af) support aggregation of at most 2-3 contiguous TVWS channels [3, 1, 2, 8].

In the research literature, Holland [35] examine TVWS spectrum availability in London in the Ofcom TVWS pilot context. This paper also analyzes the achievable capacity with aggregating available TVWS channels under two options (contiguous-only and contiguous/non-contiguous), considering mobile broadband downlink and indoor broadband provisioning use case scenarios. While these analysis results indicate promising data rates that TVWS spectrum aggregation can provide in theory, the authors do not discuss how such rates can be achieved by a practical system. From the systems perspective, there exists a long line of research prototyping and experimenting with platforms providing limited form of TVWS spectrum aggregation via frequency down-conversion of a single 20 MHz Wi-Fi channel using commodity 802.11 cards [52, 13, 37, 36, 51, 45, 39]. Up to 4 TVWS channels can be aggregated with these systems resulting in a maximum TCP (UDP) throughput of 23 Mbps (35 Mbps). While leveraging the frequency down-conversion concept, our WhiteHaul system achieves more than 500 Mbps TCP link throughput via aggregation of an order-of-magnitude more amount of, possibly non-contiguous, TVWS spectrum.

### 7 CONCLUSIONS

As described herein, WhiteHaul provides a flexible and efficient system for high capacity backhaul over TVWS. WhiteHaul is believed to be the first TVWS system that is capable of aggregating the whole UHF band utilizing both the contiguous and non-contiguous available spectrum chunks. WhiteHaul consists of hardware and software layers. The hardware layer is represented by a conversion substrate that leverages SDR-based Local Oscillator to down/up-convert between available TVWS spectrum and 5 GHz Wi-Fi channels and effectively combine the non-contiguous chunks of TVWS spectrum. The WhiteHaul software layer orchestrates the undertying wireless interfaces to maximize the system performance. The software layer consists of a novel MPTCP congestion control that is designed to efficiently distribute the traffic between the heterogeneous underlying interfaces aided by the WhiteHaul Slot Allocation Manager. A prototype implementation of WhiteHaul developed and extensively tested in a lab environment showed that WhiteHaul can aggregate almost the whole TV band and achieves nearly 600 Mbps TCP throughput using a single antenna.

Improvements and modifications may be incorporated without departing from the scope of the invention as defined by the claims appended hereto. For example, the single antenna may instead comprise a plurality of antanennae. Alternatively, the antenna comprises a dual polarised antenna.

### REFERENCES

[1] 6Harmonics. http://www.6harmonics.com/.
[2] Adaptrum. http://www.adaptrum.com/.
[3] Carlson Wireless Technologies. https://www.carlsonwireless.com/.
[4] Facebook Connectivity. https://connectivity.fb.com/high-altitude-connectivity/.
[5] FSOC. https://x.company/projects/fsoc/.
[6] LimeSDR. https://limemicro.com/products/boardsAimesdr/.
[7] Pycom—Next Generation Internet of Things Platform. https://pycom.io/.
[8] Redline Communications. https://rdlcom.com/tv-white-space/.
[9] RF Explorer. http://j3.rf-explorer.com/.
[10] USRP B210. http://www.ettus.com/all-products/UB210-KIT/.
[11] Measuring the Information Society Report 2018—Volume 2, 2018. https://www.itu.int/en/ITU-D/Statistics/Pages/publications/misr2018.aspx/.
[12] 3GPP:REL.14. Evolved Universal Terrestrial Radio Access (E-UTRA); Packet Data Convergence Protocol (PDCP) specification. Retrieved July, 2018 from https://www.etsi.org/deliver/etsi_ts/136300_136399/136323/14.03.00_60/ts_136323v 140300p.pdf.
[13] ASHOK, A., SUBBIAH, I., VARGA, G., SCHREY, M., ACHTZEHN, A., PETROVA, M., AND HEINEN, S. Whitelan: Facilitate cost-efficient sdr research with cots ieee 802.11 b/g devices. In ACM SIGCOMM Computer Communication Review (2014), vol. 44, ACM, pp. 45-52.
[14] BAHL, P., CHANDRA, R., MOSCIBRODA, T., MURTY, R., AND WELSH, M. White space networking with wi-fi like connectivity. ACM SIGCOMM Computer Communication Review 39, 4 (2009), 27-38.
[15] BEJARANO, O., KNIGHTLY, E., AND PARK, M. IEEE 802.11ac: From Channelization to Multi-User MIMO. IEEE Communications 51, 10 (October 2013).
[16] BIGGS, P., AND LOZANOVA, Y.
[17] CHANDRA, R., MOSCIBRODA, T., BAHL, P., MURTY, R., NYCHIS, G., AND WANG, X. A campus-wide testbed over the TV white spaces. ACM SIGMOBILE Mobile Computing and Communications Review 15, 3 (2011), 2-9.
[18] CORDEIRO, C., CHALLAPALI, K., BIRRU, D., AND SHANKAR, S. leee 802.22: the first worldwide wireless standard based on cognitive radios. In First IEEE International Symposium on New Frontiers in Dynamic Spectrum Access Networks, 2005. DySPAN 2005. (2005), leee, pp. 328-337.
[19] DE CONINCK, Q., AND BONAVENTURE, O. Multipath quic: Design and evaluation. In Proceedings of the 13^{th} International Conference on Emerging Networking EXperiments and Technologies (2017), ACM, pp. 160-166.
[20] DEEK, L., GARCIA-VILLEGAS, E., BELDING, E., LEE, S.-J., AND ALMEROTH, K. The impact of channel bonding on 802.11 n network management. In Proceedings of the Seventh COnference on emerging Networking Experiments and Technologies (2011), ACM, p. 11.
[21] DJUKIC, P., AND MOHAPATRA, P. Soft-tdmac: A software tdma-based mac over commodity 802.11 hardware. In INFOCOM 2009, IEEE (2009), IEEE, pp. 1836-1844.
[22] ETSI. White Space Devices (WSD) Wireless Access Systems operating in the 470 MHz to 790 MHz TV broadcast band, 2018. ETSI EN 301 598 V2.1.1.
[23] FENG, X., ZHANG, J., AND ZHANG, Q. Database-assisted multi-ap network on tv white spaces: Architecture, spectrum allocation and ap discovery. In 2011 IEEE International Symposium on Dynamic Spectrum Access Networks (DySPAN) (2011), IEEE, pp. 265-276.
[24] FERLIN, S., ALAY, O., MEHANI, O., AND BORELI, R. BLEST: Blocking estimation-based mptcp scheduler for heterogeneous networks. In IFIP Networking Conference (IFIP Networking) and Workshops, 2016 (2016), IEEE, pp. 431-439.
[25] FLICKENGER, R., OKAY, S., PIETROSEMOLI, E., ZENNARO, M., AND FONDA, C. Very long distance wi-fi networks.
[26] FLORES, A. B., GUERRA, R. E., KNIGHTLY, E. W., ECCLESINE, P., AND PANDEY, S. IEEE 802.11 af: A standard for TV white space spectrum sharing. IEEE Communications Magazine 51, 10 (2013), 92-100.
[27] GROS, A., AND TIECKE, T. Connecting the world with better maps. https://engineerng.fb.com/core-data/connecting-the-world-with-better-maps/.
[28] GUO, Y. E., NIKRAVESH, A., MAO, Z. M., QIAN, F., AND SEN, S. Accelerating multipath transport through balanced subflow completion. In Proceedings of the 23rd Annual International Conference on Mobile Computing and Networking (2017), ACM, pp. 141-153.
[29] HA, S., RHEE, I., AND XU, L. Cubic: a new tcp-friendly high-speed tcp variant. ACM SIGOPS operating systems review 42, 5 (2008), 64-74.
[30] HANDLEY, M., BONAVENTURE, O., RAICIU, C., AND FORD, A. Tcp extensions for multipath operation with multiple addresses.
[31] HANDLEY, M., RAICIU, C., FORD, A., IYENGAR, J., AND BARRE, S. Architectural guidelines for multipath tcp development.
[32] HANDLEY, M., RAICIU, C., AND WISCHIK, D. Coupled congestion control for multipath transport protocols.
[33] HARRISON, K., MISHRA, S. M., AND SAHAI, A. How much white-space capacity is there? In New Frontiers in Dynamic Spectrum, 2010 IEEE Symposium on (2010), IEEE, pp. 1-10.
[34] HARTUNG, L., AND MILIND, M. Policy driven multi-band spectrum aggregation for ultra-broadband wireless networks. In Dynamic Spectrum Access Networks (DySPAN), 2015 IEEE International Symposium on (2015), IEEE, pp. 82-93.
[35] HOLLAND, O. Some are born with white space, some achieve white space, and some have white space thrust upon them. IEEE Transactions on Cognitive Communications and Networking 2, 2 (2016), 178-193.
[36] HOLLAND, O., AIJAZ, A., PING, S., WONG, S., MACK, J., LAM, L., AND DE LA FUENTE, A. Aggregation in tv white space and assessment of an aggregation-capable ieee 802.11 white space device. In Communications (ICC), 2016 IEEE International Conference on (2016), IEEE, pp. 1-5.
[37] HOLLAND, O., RAMAN, A., SASTRY, N., WONG, S., MACK, J., AND LAM, L. Assessment of a platform for non-contiguous aggregation of ieee 802.11 waveforms in tv white space. In 2016 IEEE 83rd Vehicular Technology Conference (VTC Spring) (2016), IEEE, pp. 1-5.
[38] JOHN MAGLIACANE. SPLAT!: an RF Signal Propagation, Loss, And Terrain analysis tool. http://www.qsl.net/kd2bd/splat.html.
[39] JOHNSON, D., ZLOBINSKY, N., LYSKO, A., LAMOLA, M., HADZIC, S., MALIWATU, R., AND DENSMORE, M. Head to Head Battle of TV White Space and WiFi for Connecting Developing Regions.
[40] JOHNSON, D. L., AND MIKEKA, C. Bridging africa's broadband divide. IEEE Spectrum 53, 9 (2016), 42-56.
[41] KHALIL, M., QADIR, J., ONIRETI, O., IMRAN, M. A., AND YOUNIS, S. Feasibility, architecture and cost considerations of using tvws for rural internet access in 5g. In 2017 20th Conference on Innovations in Clouds, Internet and Networks (ICIN) (2017), IEEE, pp. 23-30.
[42] KHALILI, R., GAST, N., POPOVIC, M., AND LE BOUDEC, J.-Y. Mptcp is not pareto-optimal: Performance issues and a possible solution. IEEE/ACM Trans. Netw. 21, 5 (2013), 1651-1665.
[43] KIRKPATRICK, K. Bringing the internet to the (developing) world. Commun. ACM 61, 7 (June 2018), 20-21.
[44] KUHN, N., LOCHIN, E., MIFDAOUI, A., SARWAR, G., MEHANI, O., AND BORELI, R. DAPS: Intelligent delay-aware packet scheduling for multipath transport. In Communications (ICC), 2014 IEEE International Conference on (2014), IEEE, pp. 1222-1227.
[45] KUMAR, A., KARANDIKAR, A., NAIK, G., KHATURIA, M., SAHA, S., ARORA, M., AND SINGH, J. Toward enabling broadband for a billion plus population with tv white spaces. IEEE Communications Magazine 54, 7 (2016), 28-34.
[46] KUMBHKAR, R., ISLAM, M. N., MANDAYAM, N. B., AND SESKAR, I. Rate optimal design of a wireless backhaul network using tv white space. In 2015 7th International Conference on Communication Systems and Networks (COMSNETS) (2015), IEEE, pp. 1-7.
[47] LEE, H., FLINN, J., AND TONSHAL, B. Raven: Improving interactive latency for the connected car. In Proceedings of the 24th Annual International Conference on Mobile Computing and Networking (2018), ACM, pp. 557-572.
[48] LEE, H., VAHID, S., AND MOESSNER, K. A Survey of Radio Resource Management for Spectrum Aggregation in LTE-Advanced. IEEE Communications Surveys & Tutorials 16, 2 (2014).
[49] LIM, Y.-S., NAHUM, E. M., TOWSLEY, D., AND GIBBENS, R. J. Ed: An mptcp path scheduler to manage heterogeneous paths. In Proceedings of the 13*” International Conference on emerging Networking EXperiments and Technologies (2017), ACM, pp. 147-159.
[50] MACCARTNEY, G. R., AND RAPPAPORT, T. S. Rural macrocell path loss models for millimeter wave wireless communications. IEEE Journal on selected areas in communications 35, 7 (2017), 1663-1677.
[51] MACK, J., AND CARTMELL, J. Field trial results for a wi-fi based spectrum sharing technology in tvws. In IEEE Long Island Systems, Applications and Technology (LISAT) Conference 2014 (2014), IEEE, pp. 1-6.
[52] NARLANKA, S., CHANDRA, R., BAHL, P., AND FERRELL, J. I. A hardware platform for utilizing tv bands with a wi-fi radio. In Local & Metropolitan Area Networks, 2007. LANMAN 2007. 15th IEEE Workshop on (2007), IEEE, pp. 49-53.
[53] OECD. International cables, gateways, backhaul and international exchange points.
[54] OFCOM. Airwaves opened up to support wireless revolution, July 2019.
[55] PANIGRAHI, D., AND RAMAN, B. Tdma scheduling in long-distance wifi networks. In IEEE INFOCOM 2009 (2009), IEEE, pp. 2931-2935.
[56] PATRA, R. K., NEDEVSCHI, S., SURANA, S., SHETH, A., SUBRAMANIAN, L., AND BREWER, E. A. Wildnet Design and implementation of high performance wifi based long distance networks. In NSDI (2007), vol. 1, p. 1.
[57] RAMAN, B., AND CHEBROLU, K. Experiences in using WiFi for rural internet in India. IEEE Communications Magazine 45, 1 (2007), 104-110.
[58] RAUL KATZ, The Impact of Broadband on the Economy: Research to Date and Policy Issues, April 2012. https://www.itu.int/ATU-D/treg/broadband/ATU-BB-Reports_Impact-of-Broadband-on-the-Economy.pdf/.
[59] RAZA, U., KULKARNI, P., AND SOORIYABANDARA, M. Low power wide area networks: An overview. IEEE Communications Surveys & Tutorials 19, 2 (2017), 855-873.
[60] REIGADAS, J. S., MARTINEZ-FERNANDEZ, A., RAMOS-LOPEZ, J., AND SEOANE-PASCUAL, J. Modeling and optimizing ieee 802.11 dcf for long-distance links. IEEE Transactions on Mobile Computing 9, 6 (2010), 881-896.
[61] ROBERTS, S., GARNETT, P., AND CHANDRA, R. Connecting africa using the tv white spaces: From research to real world deployments. In The 21st IEEE International Workshop on Local and Metropolitan Area Networks (2015), IEEE, pp. 1-6.
[62] SAIFULLAH, A., RAHMAN, M., ISMAIL, D., LU, C., LIU, J., AND CHANDRA, R. Low-Power Wide-Area Network Over White Spaces. IEEE/ACM Trans. Netw. 26, 4 (August 2018), 1893-1906.
[63] SHEN, Z., PAPASAKELLARIOU, A., MONTOJO, J., GERSTENBERGER, D., AND XU, F. Overview of 3GPP LTE-Advanced Carrier Aggregation for 4G Wireless Communications. IEEE Communications 50, 2 (February 2012).
[64] SHETH, A., NEDEVSCHI, S., PATRA, R., SURANA, S., BREWER, E., AND SUBRAMANIAN, L. Packet loss characterization in wifi-based long distance networks. In IEEE INFOCOM 2007-26th IEEE International Conference on Computer Communications (2007), IEEE, pp. 312-320.
[65] TALBOT, D. The Unacceptable Persistence of the Digital Divide, December 2016.
[66] VAN DE BEEK, J., RIIHIJARVI, J., ACHTZEHN, A., AND MAHONEN, P. Tv white space in europe. IEEE Transactions on Mobile Computing 11, 2 (2012), 178-188.
[67] VASISHT, D., KAPETANOVIC, Z., WON, J., JIN, X., CHANDRA, R., SINHA, S., KAPOOR, A., SUDARSHAN, M., AND STRATMAN, S. Farmbeats: An iot platform for data-driven agriculture. In 14th fUSENIXg Symposium on Networked Systems Design and Implementation (fNSDIg 17) (2017), pp. 515-529.
[68] VIERNICKEL, T., FROEMMGEN, A., RIZK, A., KOLDEHOFE, B., AND STEINMETZ, R. Multipath quic: A deployable multipath transport protocol. In 2018 IEEE International Conference on Communications (ICC) (2018), IEEE, pp. 1-7.
[69] YAACOUB, E., AND ALOUINI, M. A Key 6G Challenge and Opportunity—Connecting the Remaining 4 Billions: A Survey on Rural Connectivity. CoRR abs/1906.11541 (2019).
[70] YING, X., ZHANG, J., YAN, L., ZHANG, G., CHEN, M., AND CHANDRA, R. Exploring indoor white spaces in metropolises. In Proceedings of the 19th annual international conference on Mobile computing & networking (2013), ACM, pp. 255-266.
[71] ZHANG, J., ZHANG, W., CHEN, M., AND WANG, Z. Winet: Indoor white space network design. In 2015 IEEE Conference on Computer Communications (INFOCOM) (2015), IEEE, pp. 630-638.

The invention can be further understood with reference to the following paragraphs in which:

Abstract

We address the challenge of backhaul connectivity for rural and developing regions, which is essential for universal fixed/mobile Internet access. To this end, we propose to exploit the TV white space (TVWS) spectrum for its attractive properties: low cost, abundance in under-served regions and favorable propagation characteristics. Specifically, we propose a system called WhiteHaul for the efficient aggregation of the TVWS spectrum tailored for the backhaul use case. At the core of WhiteHaul are two key innovations: (i) a TVWS conversion substrate that can efficiently handle multiple non-contiguous chunks of TVWS spectrum using multiple low cost 802.11n/ac cards but with a single antenna; (ii) novel use of MPTCP as a link-level tunnel abstraction and its use for efficiently aggregating multiple chunks of the TVWS spectrum via a novel uncoupled, cross-layer congestion control algorithm. Through extensive evaluations using a prototype implementation of WhiteHaul, we show that (a) WhiteHaul can aggregate almost the whole of TV band with 3 interfaces and achieve nearly 600 Mbps TCP throughput; (b) the WhiteHaul MPTCP congestion control algorithm provides an order of magnitude improvement over state of the art algorithms for typical TVWS backhaul links. We also present additional measurement and simulation based results to evaluate other aspects of the WhiteHaul design.

1 Introduction

The beneficial impacts with Internet connectivity have been well documented [73]. However, almost half the world's population is still unconnected [13]. And, according to 2018 World Bank estimates, almost half the world's population is rural who make up the large fraction of the unconnected. This is, for example, apparent from the global mobile Internet penetration figures. In some regions like North America 4G/LTE amounts to nearly 90% of the overall mobile subscriptions and fast moving to 5G; however it is just around 7% in Sub-Saharan Africa with higher percentages of rural population [27]. In the past decade, there have been a series of efforts to remedy this through community cellular networks, initially focused on voice and SMS services [15, 41, 91] and more recently on LTE based mobile broadband Internet service [51, 80] leveraging the emergence of open-source software platforms, etc. Recent regulatory developments [67] promote such local wireless access networks by allowing the use of “unused” licensed spectrum at nominal cost.

Despite these developments, the infrastructure to connect the sparsely populated or low-income rural and developing regions is limited and remains a major roadblock [20, 54, 80, 83]. A key challenge is to create economical backhaul networks that connect access networks to the wider Internet [50, 56, 65]. Traditional approaches for backhaul connectivity rely on fiber, licensed microwave or satellite solutions that have high CAPEX or OPEX costs [88].

In this paper, we propose to exploit spectrum white spaces towards low cost backhaul for underserved regions. In particular, we focus on the TV white space (TVWS) spectrum—the portions of UHF TV bands unused by TV transmitters and wireless microphone users (the primary users of this spectrum). Led by the U.S. in 2008, several countries have made the TVWS spectrum unlicensed subject to interference protection for primary users (e.g., TV receivers) that requires consulting a geolocation database for available spectrum at a given location and time. TVWS spectrum is attractive for backhaul connectivity in rural and developing regions for multiple reasons. First, TVWS spectrum costs little (just database access fees) and there is an ample amount of it available in rural areas (in the region of 200+ MHz) with fewer TV transmitters and rare wireless microphone use, for our case study in Scotland. In developing countries, almost all of the UHF band is available as white space due to non-existent or limited presence of over-the-air TV [50].

Second, UHF TV spectrum has superior propagation characteristics compared to other higher frequency bands in terms of both range and non-line-of-sight (NLoS) propagation in presence of foliage and obstructions [21, 32, 49, 50, 56]. For example, it is possible to get 4 times greater range with the TVWS spectrum than with the 2.4 GHz unlicensed spectrum used by Wi-Fi [21, 50]. This suggests lower infrastructure costs as fewer number of relays are sufficient to enable backhaul connectivity over long distances.

Unsurprisingly, the promise of TVWS spectrum for backhaul connectivity in rural and developing regions has been recognized in the literature [50, 52, 56, 57, 80]. However, existing TVWS systems (discussed further in § 6)—both commercial solutions and research prototypes—fail to fully realize this promise as the throughput they can achieve is limited to a few tens of Mbps—insufficient for even a modest community of network users.

We present WhiteHaul, the first TVWS based system that can deliver an order-of-magnitude higher throughput (over 500 Mbps) than the state-of-the-art by addressing several significant challenges and constraints pertinent to the backhaul use case, as outlined below and elaborated in § 2. First, individual TVWS channels are narrow (6/8 MHz depending on the regulatory regime). Second, available channels may not be contiguous depending on the presence of primary users (e.g., TV transmitters). So it is imperative to aggregate multiple possibly non-contiguous TVWS channels to realize high-speed TVWS backhaul connectivity. Third, it is desirable to use a single antenna at each backhaul link endpoint (even with multiple radio interfaces) because of the larger size of TVWS antennas, as also previously articulated in [78]-having multiple antennas requires separation in the order of meters and hence higher towers, steeply increasing the cost and deployment complexity [56, 72]. Fourth, TVWS spectrum exhibits a high degree of diversity in terms of chunk sizes, transmit power and interference levels, especially for long-distance backhauling, and these need to be taken into account in any design. Lastly, backhaul traffic exhibits high degree of asymmetry and temporal fluctuations.

In this paper, we make the following contributions pertinent to the design, implementation and evaluation of the WhiteHaul system:

Considering Scotland as a representative country, we present a case study with an extensive analysis of salient aspects of TVWS spectrum characteristics from a backhaul use case perspective; and we analyze real-world rural backhaul traffic characteristics (§ 2).

Informed by the above analysis, we design and implement the WhiteHaul system (§ 3 and § 4) that features several innovations in both hardware and software. Chief among them are: (i) a TVWS conversion substrate to efficiently handle multiple non-contiguous chunks of TVWS spectrum with a single antenna using multiple low cost COTS 802.11n/ac cards; (ii) a novel way of leveraging MPTCP as an abstraction of a high-speed link-level tunnel, and efficiently aggregating multiple TVWS spectrum chunks (sub-links) via a novel uncoupled, cross-layer congestion control mechanism that is agile to underlying variations in available bandwidth of sub-links.

We extensively evaluate WhiteHaul using our prototype implementation and simulations driven by real-world backhaul traffic traces to quantify the aggregate backhaul link throughput it can achieve in various network settings, e.g., number and width of TVWS spectrum chunks, and link conditions (§ 5). In particular, we show that WhiteHaul can aggregate almost the whole of TV band with 3 interfaces and achieve nearly 600 Mbps TCP throughput. The WhiteHaul MPTCP congestion control algorithm is also shown to provide an order of magnitude improvement over the state of the art algorithms in the presence of typical loss rates experienced by TVWS backhaul.

From a wider perspective, NLoS propagation capabilities of TVWS, and the resulting cost advantages due to shorter towers or fewer relays, make our work complementary to alternative backhaul solutions based on licensed/unlicensed microwave and long-distance Wi-Fi (e.g., [70]) that require line-of-sight. Also, the use of TVWS for backhauling in general and WhiteHaul in particular compares favorably, especially in terms of cost, ease of deployment and robustness, with respect to alternative technologies being explored for addressing connectivity challenges in rural and developing regions (e.g., drones [4], free space optical communications [5], Google Project Loon [54], millimeter waves [61]). Our work is also complementary to other recent work that focuses on leveraging spectrum white spaces for access networks [18, 40] as well as works that focus on inter-working between commercial and community cellular networks [39, 79].

2 Tvws Backhaul Links: Characteristics and Challenges

As a way to substantiate the challenges associated with using TVWS spectrum for backhaul links in underserved regions, here we consider Scotland as a representative country and present a case study examining the nature of TVWS spectrum in the 470-790 MHz TV band as per the ETSI Harmonised Standard for White Space Devices [28]. To this end, we represent Scotland as a set of pixels, each corresponding roughly to a square of size 6 km2. For the center location of each such pixel, we query a commercial geolocation database to obtain the available TV channels at that location along with allowed power levels. The TVWS spectrum availability results for different area types, corresponding to area classification in Scotland based on population density, confirm the ample availability in rural areas (e.g., 38 8 MHz wide TV channels available in 70% of rural locations), broadly in agreement with prior studies (e.g., [37, 85]). Our focus in the rest of this section is to shed light on several salient issues that need to be accounted for when designing TVWS backhaul links.

Spectrum fragmentation. We now focus on the inhabited rural areas to understand their TVWS spectrum characteristics. We first look into the extent to which the available TVWS spectrum is fragmented. For this, we define a spectrum chunk as a set of contiguous TVWS channels available at a given location. Quantifies the extent to which TVWS is fragmented in rural areas. For example, in 60% of the locations, the spectrum is fragmented into at least 6 chunks and in only 20% of the locations is the spectrum available in 4 or fewer chunks. Such a high degree of spectrum fragmentation is due to the presence of multiple lower power TV relays/amplifiers needed to extend the coverage of the primary DTT transmitters. This creates gaps in available TVWS spectrum as access to channels amplified by such relays are restricted by the geolocation database.

Spectrum chunk size diversity. The spectrum is distributed across chunks through CDFs of the percentage of total available spectrum that is covered by the one, two, three and four largest chunks. We observe that only about half the available spectrum is covered by the largest chunk (red solid curve) in half the locations, and that even top four chunks combined cannot cover all the available spectrum in 80% of the locations. Distribution of chunk sizes within each of the four largest sized chunks. These results demonstrate the significant diversity in chunk sizes, which adds further complexity to the problem of aggregating TVWS spectrum in that traffic should be distributed across chunks accounting for this diversity.

Power asymmetry. With the TVWS spectrum, the geolocation database needs to be queried to determine the available set of channels and power levels at a location, and it is possible that these could be substantially different between link endpoints that are some distance apart. We examine the potential power asymmetry resulting from this issue. The allowed power level differences for different point-to-point (PtP) link distances for each channel in the common set of channels available at both ends of the link. We observe that the power differences can be quite significant for longer (20 Km) links with a median around 25 dB. This effect is also seen for shorter (5 Km) links where only in 10% of the cases is the transmit power difference less than 6 dB. Note that this power asymmetry effect is unique to TVWS based backhaul setting and not present in other approaches used in the literature for low-cost backhaul such as long-distance Wi-Fi [26, 31, 68, 70, 75, 82].

Power differences can also occur between different channels available at a link endpoint. This effect is quantified where maximum power differences between channels within each of the four largest chunks is shown. We see that channels within a chunk can have quite different power levels; for example, the median power difference within 1st and 2nd chunks is around 12 dB. As such, the set of chunks and their size need to be carefully chosen to minimize these above highlighted power asymmetry effects. Moreover, time allocation for each end of a backhaul link needs to account for the effective capacity of the link and traffic demand from each direction, the former being affected by transmit power used for each of the chunks. We factor these observations in our design (§ 4.2).

Interference. While consulting the geolocation database is mandatory to access the TVWS spectrum, it cannot capture receiver-side interference characteristics that could affect the quality of TVWS transmission from a distant transmitter. To illustrate this point, we suppose a TVWS receiver at the rooftop of our office building and consider a transmitter on top of another building 3 km away. Based on available TVWS channels and allowed power levels at the transmitter location by querying the geolocation database, then accounting for path loss (calculated using the SPLAT!RF planning tool [48]) and antenna gains, we obtain expected signal power at the receiver on channels available at transmitter side. At the receiver, we use a spectrum analyzer to estimate the level of interference on different channels across the whole TV band. We see that the channels available at the transmitter can be very different from the receiver in terms of received signal power and interference levels. This highlights the importance of measuring and considering receiver-side perspective in choosing spectrum chunks, which we do in our design (§ 3, § 4.2.1).

Traffic characteristics. Effective backhaul network design requires a good understanding of the characteristics of traffic it is expected to carry. To this end, we collected trace of traffic from Tegola [10], a long-running rural community wireless access network, as seen by its leased fiber backhaul link (with 200 Mbps symmetric upstream and downstream bandwidth limit). This network serves at least 250 households and local businesses. A week long backhaul traffic profile in the downstream (towards access network) and upstream directions. We observe a high degree of asymmetry with average daily downstream traffic much higher, around 63 GBytes, compared to average upstream traffic each day (only about 4 GBytes). We also note that, although there is some apparent diurnal pattern, traffic in both directions fluctuates substantially over time. To understand the degree of fluctuation at different time granularities (epochs), The CDF of variation in downstream traffic from one epoch to the next for different epoch lengths. These results indicate considerable degree of traffic variation for longer epochs but marginal variation with the smallest epoch size we could obtain for this trace, which is based on data collected every 30 s.

3 Whitehaul Overview

This section gives an overview of our proposed WhiteHaul system for TVWS based backhaul. Its design addresses the various pertinent challenges and constraints highlighted in the previous section. First, the TVWS channels are narrow and the available spectrum is fragmented. This requires aggregation of contiguous and non-contiguous spectrum chunks across the UHF TV band spanning a few hundred MHz. However, wide band spectrum aggregation is complex and expensive as it involves dealing with voltage-controlled oscillator (VCO) pulling effects and careful RF filter design, which are evident from the RF front end design challenges for LTE/5G carrier aggregation [60, 69]. Given the somewhat relaxed form factor requirement in our setting and keeping cost in mind, we take an alternative approach that combines multiple low cost COTS Wi-Fi cards with a custom designed frequency conversion substrate for down/up conversion to TV band frequencies.

Second, given the large size of TVWS antennas, we constrain each backhaul link endpoint to use a single antenna to avoid higher towers, which steeply increase the cost and deployment complexity. Allowing multiple antennas requires sufficient separation between them in the order of meters to counter side/back lobe interference effects that can hurt link throughput by 2.5× [47], and this in turn increases the tower height. Higher towers can also result in reduced transmit power limit due to TVWS regulatory constraints on antenna height [44]. Third, given the potential asymmetry in power, interference and traffic over TVWS based backhaul links as demonstrated in our characterization study, our design allows for flexible and dynamic time allocation for communication in each direction of a WhiteHaul link. Fourth, having the hardware capability to communicate over multiple different TVWS spectrum chunks is alone insufficient to realize high-speed TVWS based backhaul. What is needed is a glue to combine the capacity across the multiple spectrum chunks and accounting for their diversity, thereby creating a link level tunnel abstraction. Among the different multipath tunneling approaches, we find MPTCP to be the best fit for our use case. Even so, the existing MPTCP congestion control schemes (e.g., LIA[71] and OLIA[53]) are slow in responding to the change of underlying link capacity of each subflow/sub-link. This motivates us to develop a new cross-layer MPTCP congestion control algorithm for fast adaptation, thereby achieve high aggregated throughput across sub-links.

WhiteHaul is intended to realize point-to-point (PtP) TVWS based backhaul links, meaning a WhiteHaul node forms the endpoint of such a link. A basic application scenario where a WhiteHaul link connects an access network (serving end-user devices) and the Internet. We do not make any assumptions on the nature of the access network, which could take several forms including a community cellular network (e.g., [80]). While it is fairly straightforward to go from the case of one WhiteHaul link to a path or mesh network with multiple WhiteHaul links with suitable spectrum usage coordination amongst them, we focus on the single link case in this paper. Also, we adopt a Master-Slave model in that one end of a WhiteHaul link acts as the Master Node and the other as the Slave Node with the former responsible for link configuration decisions (e.g., spectrum to use for interfaces on both sides). The Master and Slave coordinate over an out-of-band control channel while carrying user traffic over multiple data channels that each operate on a separate TVWS spectrum chunk. There are as many data channels as the number of interfaces at WhiteHaul end nodes making up the link. For transporting data packets over the data channels bidirectionally we create a MPTCP tunnel by leveraging a SOCKS5 proxy, a commonly used approach in several MPTCP studies [23, 64, 77]. We install the client and server side of the SOCKS5 on the Slave and Master nodes respectively. For reasons elaborated later in section 4.2, WhiteHaul links operate in time-division duplexing (TDD) mode, meaning the Master and Slave take turns in time, possibly of different durations in each direction, to communicate over their respective data interfaces.

The schematic of the WhiteHaul node architecture, that consists of two layers: the Hardware Layer and the Software Layer. The hardware layer is composed of the physical wireless interfaces used for both control and data communication as well as the TVWS conversion substrate for the data interfaces. For the data interfaces, we use COTS 802.11n/ac Wi-Fi cards operating in 5 GHz band. The conversion substrate is responsible for frequency up/down conversion between available TVWS spectrum chunks and 5 GHz Wi-Fi channels. For the control interface, we use LoRa [74], a low-power wide area network technology, that costs a few dollars a piece, operates in unlicensed sub-GHz bands, and provides data rates of tens of Kbps over long distances up to 40 Km.

The WhiteHaul software layer orchestrates the underlying interfaces to maximize the overall system performance. It is made up of three modules: (i) the Coordination Module facilitates communication between the Master and Slave nodes via the underlying LoRa control interface; (ii) the Interface Configuration Module configures the TVWS spectrum chunks and transmit power of data interfaces as decided by the Master node. These configurations are based on the TVWS spectrum availability information obtained from the geolocation database and local low-cost spectrum sensing from both ends of the WhiteHaul link; (iii) the Traffic Management Module performs two functions. One, by the Slot Allocation Manager, is to adapt the time allocation between Master-Slave (forward) and Slave-Master (reverse) directions, every epoch, depending on the effective capacity and traffic demand of forward and reverse links. The Traffic Scheduler is responsible for the other function to efficiently schedule the traffic among the underlying data interfaces using a modified variant of MPTCP, aided by advisory signals from the Slot Allocation Manager.

4 System Design & Implementation

4.1 Hardware Layer

4.1.1 TVWS Conversion Substrate. As previously stated, this part of the hardware layer converts between 5 GHz and TVWS spectrum. The schematic of its design for the case of two 802.11n/ac data interfaces. As shown, data interfaces as well as the substrate, specifically the local oscillator (LO), are dynamically controlled by the Interface Configuration Module to set parameters such as oscillator frequencies, channel bandwidths and power levels while ensuring compliance with TVWS spectrum regulations. In general, we target a flexible and modular design for the substrate to allow its realization with replaceable/configurable components as per link requirements and cost considerations (e.g., trade off between noise and linearity). Our implementation consists of a desktop (running Ubuntu Linux 14.04) connected to a set of Mikrotik RB922UAGS-5HPacD Router-Boards with 802.11n/ac cards, acting as data interfaces, via Gigabit Ethernet. The desktop also hosts a USRP B210 [12] per data interface for use as a LO, as described below.

SDR based Local Oscillator. The LO component plays the key role of translating RF/IF signal up/down to a different frequency band by multiplying it with the sinusoidal signal it generates. Previous works employing the frequency conversion concept (e.g., [16, 63]) have relied on Voltage Controlled Oscillators (VCOs) to generate the LO signal; specifically, these VCOs take a control voltage as input to determine the frequency of output LO signal. As VCOs operate under high non-linearity and produce unwanted emissions, they cause frequency fluctuations (harmonics and phase noise) of the output signal that blur the output IF signal when used in down-conversion and degrade its Signal-to-Noise Ratio (SNR). Our experiments validate this effect and show, for instance, that a VCO oscillator (with 69 dBc Hz phase noise at 1 kHz offset frequency) used to downconvert from 5 GHz to UHF band can degrade the SNR value of the output IF signal by 5 dB. Having two of these VCOs, one in the transmit chain and another in receive chain, can reduce the overall SNR level of the system by 10 dB.

So to avoid such degradation, we take a different approach and use a SDR board (USRP B210 in our prototype) to generate a sinusoidal signal without any distortion or phase noise. The SDR-generated LO signal can then be fed to the to generate the up/down converted signal. Our approach not only results in a higherSNR signal compared to VCO oscillators by 4 dB but also provides high flexibility in (re-)configuring the center frequency of the generated signal by the Interface Configuration Module. On the other hand, lack of such flexibility with the VCO due to the low granularity of the tuner voltage (steps of 0.25V which maps to steps of 20 MHz in the generated LO signal) leads to misalignment in center frequency.

Separate Transmit and Receive Paths. Our design is also distinct from prior work in that it uses two separate transmit and receive paths, which allows for fine-grained configuration for RF components to optimize signal quality of each path. To realize this separation, we make use of two fast Single Pole Double Throw (SPDT) RF switches with 35 ns switching time, one interfacing with the 802.11 card and the other before combiner/splitter and UHF antenna. These switches have a wide bandwidth range from 500 to 6000 MHz, allowing operation in both 5 GHz and UHF bands.

The transmit path has a configurable RF attenuator followed by a high-pass filter to cut out spurious emissions from the 802.11 interface. Next is a highly linear down-conversion mixer that supports wide range of frequencies from 3700 to 7000 MHz and is driven by the SDR based LO as described above. The resulting IF signal goes through a low pass filter to remove mixer related non-linearities. Then a low noise power amplifier (PA), capable of 27 dBm output power and with a low noise figure of 1.2 dB, is used. This is a voltagecontrolled amplifier which can be adjusted (by changing the voltage level) to stay in the allowed transmit power. The amplified signal so generated is then fed to combiner/splitter through another RF switch.

On the receive path, we have a low-pass filter to eliminate unwanted signals before going through a low noise amplifier (LNA), which in our prototype has a high gain of 22.5 dB, ultra low noise figure of 0.5 dB and wide operational bandwidth range from to 3000 MHz. The up-conversion mixer translates the received UHF signal into the GHz band with help of LO, as above. We only use one LO for a pair of transmit and receive paths to make sure that the center frequency of the up-converted signal is the same as that of the RF signal down-converted in the transmit path. Following the mixer, we have a high pass filter to remove the unwanted signal from the mixer. Finally, a configurable attenuator to avoid saturating the receive chain on the 802.11 interface.

Combiner/Splitter. To satisfy our design constraint of using a single antenna, while using multiple interfaces towards a high capacity backhaul link, we have a RF power combiner/splitter in the design that can combine different transmit paths (from different 802.11 interfaces) into one output that is fed to the antenna or split the received UHF signal into multiple receive paths. In our prototype, we use a combiner/splitter with high isolation (25 dB typical) to prevent leakage between paths. Moreover, it can handle high transmit power up to 10 W (aggregated), and has input ports (for combining up to 5 different 802.11 cards) with a total bandwidth of 320 MHz that can span the whole TV band.

4.1.1 Coordination and Synchronization. The control interface enables the coordination between the Master and Slave ends of a WhiteHaul link, which is useful for two purposes. First, for the Slave node to notify the Master about the spectrum sensing information at its location as well as its traffic demand every epoch (30 seconds in our implementation; the red slots represent the control channel transmission). Second, for the Master to notify the Slave about the set of TVWS spectrum chunks to use for its interfaces as well as the time slot duration in the reverse direction. In our implementation, we realize this control communication channel using low-cost Pycom LoRa gateways [7] that operate on very narrow channels (7.8-500 KHz) in 868 MHz spectrum band and are capable of achieving few tens of Kbps data rate over long distances, up to 40 Km. Along with a control interface, each WhiteHaul node is also equipped with a GPS receiver to facilitate localization and time synchronization, latter for TDD operation.

4.2 Software Layer

4.2.1. Interface Configuration. This module is responsible for the configuration of data interfaces at WhiteHaul link endpoints with spectrum chunks and power levels via coordination over the control interface. As a basic step, the Master periodically checks with the geolocation database (as required by the regulator) about TVWS spectrum availability and allowed power levels at both Master and Slave node locations. In addition, we equip each WhiteHaul node with a low cost spectrum analyzer (RF Explorer [9] in our implementation) to estimate the interference in available TVWS channels. This is motivated by the observation made in § 2 about interference and recent work (e.g., [42]) that observes that aggregate interference from multiple nearby transmitters can impact the quality of available channels. So, using the spectrum analyzer, each WhiteHaul node sweeps the whole TV band periodically to obtain the signal level on all the available TVWS channels as an estimate of interference on those channels. Note that it takes 5.6 seconds to sweep the whole TV band, which is sufficient to obtain an up-to-date measurement of interference on individual channels (and thereby the link quality)—link quality varies less frequently in our setting compared to Wi-Fi spectrum due to fewer and relatively static number of interferers. The Slave node then syncs all its sensing information with the Master node. Here the spectrum analyzer helps to quantify the interference level (at both endpoints); however, this is insufficient to determine the allowed TX power on different TVWS channels. To this end, WhiteHaul endpoints consult the geolocation database.

Using the sensing information, the Master then estimates the SINR for each of the TVWS channels commonly available between the endpoints in both forward and reverse directions. This involves estimating the received signal power on the available TVWS channels common to both endpoints. For this, we use the SPLAT RF planning tool1 [48] to estimate the path loss in each direction along with allowed TX power and antenna gains. Based on the above, the link SINR for each TVWS channel is estimated as the lower of the two values for forward and reverse directions. With this channel-level SINR for the link in hand, the question is to decide on the TVWS spectrum chunks for the node interfaces. For this, we start with identifying the potential spectrum chunks considering contiguous set of available channels on both ends. Then, keeping in mind the number of data interfaces available, a subset of chunks (with center frequencies and chunk sizes that are greater or equal to 802.11ac channel widths (20/40/80 MHz)) are selected from all possibilities with the aim of maximizing the minimum channel-level SINR for each chunk. This may result in picking smaller sized chunks (with higher SINR yielding TVWS channels) instead of larger chunks with lower average SINR. Note that the power level chosen for a chunk is limited by the lowest power allowed among the constituent TVWS channels. So by maximizing the minimum SINR in a chunk and across both link directions, we address the power asymmetry effect highlighted in § 2. We let the modulation and coding scheme (MCS) be automatically adapted by the 802.11 interfaces via the default builtin mechanism. Note that transmission over UHF spectrum via the conversion substrate is oblivious to MCS used by endpoint interfaces.

4.2.2 Slot Allocation. As noted earlier, we design WhiteHaul links to operate in TDD mode. This not only provides more flexibility and control for traffic scheduling across interfaces but also is essential given our choice to use to low-cost COTS 802.11 cards based on CSMA. Concerning the latter, the root of the issue is that in 802.11 each node senses the spectrum for a certain time period given by DIFS (34 ps) before attempting to transmit. When the link distance is longer than 10.2 Km, one end of the link cannot hear the other within this period, which then leads to collisions from potential simultaneous transmissions by both ends. Indeed, this observation has motivated the shift to time division multiplexing (TDM) based MAC protocols in the literature for long-distance Wi-Fi (e.g., [70]).

While our TVWS conversion substrate with separate transmit and receive paths allows for fast switching between the transmit and receive modes (35 ns), the key issue with TDD is deciding on the time allocation for each direction (forward/reverse). The long-distance Wi-Fi literature (e.g., [26, 68, 70]) has taken the simplest approach to this issue by using static equal time share in both directions but we observe this is not an efficient approach for backhaul and TVWS settings. First, as shown earlier in § 2, backhaul traffic can be highly asymmetric, with more traffic in the downstream (access network) direction, and also varies over time. Second, with TVWS spectrum, power asymmetry and interference effects may result in different effective capacities between forward and reverse directions. The above suggests an adaptive time split to counter these effects.

In view of the above, we seek a dynamic time allocation for forward and reverse link directions, driven by traffic demand and effective sub-link capacities (latter obtained via the Interface Configuration module). Note that each sub-link here corresponds to each of the underlying data interfaces. We adapt the time allocation for each direction at a coarser time granularity of epochs. The epoch duration in our implementation is chosen to be 30 s to match with traffic variability; effective capacities of sub-links vary even less frequently in our setting. However note that WhiteHaul design is agnostic to the particular choice for epoch duration. Within each epoch, to avoid undesirable TCP effects we switch the use of the link between forward and reverse directions at a finer time granularity of slots (20 ms in our implementation as per [70]). Allocation of slots for each direction within an epoch is proportional to the relative time allocation at the epoch level between forward (Master-Slave) and reverse (Slave-Master) directions. An example where two thirds (one third) of the slots within each epoch are allocated to the forward (reverse) direction. The decision on relative time allocation between forward and reverse directions is made at the Master based on locally available information and that obtained from the Slave over the control interface. It is worth noting that the time allocation decision is made after configuring the interfaces with the available spectrum chunks. The key idea behind our approach is to choose the fraction of time allocated to forward and reverse directions in an epoch so that the total backlogged traffic in both directions is minimized. More precisely, at the start of each epoch t, the Master solves the following optimization problem:

Where θi t is the effective sub-link capacity via interface i at the start of epoch t. tF and t_{R} are the fractions of time within the upcoming epoch allocated for the forward and reverse directions respectively. VF t and VR t are, respectively, traffic volumes in forward and reverse directions for the upcoming epoch t. Each of these traffic volumes are the sum of forecasted traffic demand in the coming epoch t and backlogged traffic carrying over from the previous epoch. We consider a simple forecasting approach of assuming that the demand in the coming epoch will be same as in the previous epoch, which is justified from the results in § 2 for small epoch durations (30 s in our case).

4.2.3. Traffic Scheduling. The TVWS conversion substrate in the WhiteHaul hardware layer described earlier in this section provides the physical capability to aggregate TVWS spectrum across multiple spectrum chunks over different interfaces. But translating this capability to higher layer aggregated data rates requires a way to concurrently use multiple interfaces and distribute backhaul traffic among them. We seek to realize this aggregation in a transparent manner to end-user traffic so as to give the abstraction of a high-speed link-level tunnel through which user traffic is transported across. We find Multipath TCP (MPTCP) a natural fit for our use case to meet the above mentioned requirements. Moreover, it offers a reliable bit pipe like TCP while also handling packet reordering from striping user traffic across multiple interfaces. It also automatically adapts to any changes to underlying sub-link capacities or slot durations. In contrast, the other multipath tunnelling solutions (e.g., MLVPN [6] that is based on the TUN/TAP technique [11]) that operate over multiple UDP or TCP sessions simply do not meet our key requirements; e.g., quickly adapting to sub-link capacities, handling packet reordering, and re-transmitting lost packets within and across sub-links. However the default MPTCP with a coupled congestion control algorithm (e.g., LIA [71], OLIA [53]) is not suitable for our purpose as its main focus is on shifting traffic from congested to less congested paths to preserve network fairness among competing TCP flows. We have a single logical flow that needs to efficiently utilize the available capacity to maximize aggregate link data rate. Even the uncoupled variant with the commonly used CUBIC [36] fails to quickly and accurately track the changes in time split between link directions, sub-link capacities and/or losses, as we demonstrate in § 5.

Motivated by the above, we propose a new cross-layer and uncoupled congestion control algorithm that is tailored for MPTCP use in WhiteHaul. Information from the Slot Allocation Manager is used to dynamically adjust the congestion window (cwnd) size of each individual subflow (bound to a different interface) according to its current effective capacity. This allows WhiteHaul MPTCP to exploit the available capacity of each subflow even as it varies over time. The Slot Allocation Manager periodically queries the rate adaptation module in each of the underlying COTS Wi-Fi cards for the current data rate used. At the start of each epoch, the Slot Allocation Manager sends an advisory signal to the MPTCP congestion control module (through Linux filesystem, sysfs) indicating the estimated effective capacity of each subflow, determined as the product of corresponding sub-link's effective capacity (the average data rate of the sub-link over epoch duration) and the fraction of time allocated to the endpoint in question. MPTCP then calculates a target cwnd value for each subflow by multiplying the advertised effective capacity and minimum RTT estimate it holds2. The Slot Allocation Manager realizes a time synchronous mechanism (aided by GPS based clock synchronization across link endpoints over the control interface) that holds the packets or passes them to the underlying layer based on the current time slot schedule (forward or reverse time slot). Note that we do not change the underlying COTS Wi-Fi cards nor their rate adaptation module; however, we adapt the sending rate over each subflow through careful adjustment of the corresponding congestion window. WhiteHaul initially increases cwnd rapidly (100 packets per RTT in our implementation) until it reaches the target value. Thereafter, WhiteHaul keeps increasing cwnd slowly (one packet per RTT) while monitoring the queuing delay. When the queuing delay exceeds a certain delay budget, cwnd is reduced back to the target value. In this way, WhiteHaul prevents self-inflicted packet losses by controlling the queue occupancy of network interfaces. Additionally, even when a packet is dropped for any reason (e.g., low SINR) WhiteHaul is designed to quickly return back to its target, ensuring that the subflow capacity is fully used.

Algorithm 1 highlights the key part of our algorithm, which we implemented in the Linux Kernel. In short, when a new ACK is received on subflow (i), which begins a new window of data, the average queuing delay (aqd) is computed (lines 2-3). Thereafter, the weight factor (αi), which dictates the increase rate of cwndi, is updated (lines 4-10). The value of αi becomes large when cwndi is lower than the target window (Ωi) and also the average queuing delay is smaller than the queuing budget (λi), ensuring that during the congestion avoidance phase (lines 14-15) cwndi is increased rapidly until it reaches Ωi. Otherwise, cwndi is increased slowly (similar to standard TCP). At the beginning of every window of data, WhiteHaul examines whether it is allowed to reset cwndi to Ωi (lines 11-13), making sure that the queue occupancy of underlying wireless interface of subflow (i) stays below a certain threshold. Finally, when a loss is detected on a subflow, by receiving three duplicate ACKs, WhiteHaul reduces cwnd gently (lines 18-19).

5 Evaluation

In this section, we present a wide ranging evaluation of WhiteHaul, assessing all aspects of its design. This includes: (i) benchmarking its spectrum aggregation and conversion efficiency relative to the ideal case using our prototype implementation; (ii) experimentally evaluating WhiteHaul MPTCP using our Linux kernel implementation to compare its congestion control algorithm with commonly used OLIA (coupled) and CUBIC (uncoupled) algorithms; (iii) additional measurement based and simulation studies (mostly driven by real-world traffic traces) to evaluate other aspects of WhiteHaul.

Compliance with regulations. Besides having to periodically query a geolocation database for available TVWS channels and their allowed power levels at the operating location, another key requirement for white space devices is to comply with the transmit spectrum mask related regulations. The latter is to ensure power leakage into adjacent channels under the prescribed limit so as not to cause interference to incumbents. To verify that our WhiteHaul prototype meets this requirement, we measured its out-of-band (OOB) emissions at different 802.11ac channel widths it can be configured to (20/40/80 MHz) using a spectrum analyzer (from Keysight) and find that OOB from our prototype is well within the limit specified by ETSI [28] for Class 1 TVWS devices (the relevant class for our outdoor and backhaul use case). For instance, with 80 MHz channel, the OOB EIRP spectral density (POOB) with WhiteHaul is −103.8 dBm/Hz for the adjacent 100 KHz spectrum, which is as per Class 1 device requirements. We omit the detailed results with spectrum analyzer screenshots due to space restrictions.

Spectrum conversion and aggregation efficiency. We now study aggregate TCP throughput obtained with WhiteHaul in all possible two and three interface combinations of 802.11ac channel widths supported by our interface cards (20, 40 and 80 MHz3). The flexibility with WhiteHaul allows us to down-convert any 5 GHz channel to TV band by appropriately configuring frequency of the SDR based LO. Our experimental setup consists of two Intel 17 machines (7567U processor at 3.5 GHz, 8 GB of RAM) that run the software layer of two WhiteHaul nodes. Both machines have Ubuntu 16.04 with our modified MPTCP Linux kernel implementation (as described in § 4.2.3). Each machine is connected to a WhiteHaul TVWS conversion substrate through a GbE interface. The two WhiteHaul nodes making up the endpoints of the link under test are placed in the same lab few meters apart. We use the unoccupied 5 GHz Wi-Fi spectrum in our environment in the range of 5500-5750 MHz. For traffic generation, we use iperf to generate TCP traffic between the endpoint machines. Note that this setup reflects the whole WhiteHaul system except for the control interface part, which is evaluated separately. We have experimented with two variants of this setup, one with two and the other with three 802.11ac interfaces at each endpoint.

The throughput results with WhiteHaul for two and three interface scenarios. Here MPTCP throughput achieved using the above setup with WhiteHaul after down conversion and aggregation is reported. In effect, each interface ends up using a TVWS spectrum chunk of the specified width. We see that WhiteHaul can provide maximum throughput up to 446 Mbps when using two 80 MHz channels. And with three interfaces using three 80 MHz channels packed together with little channel spacing (aggregation of 240 MHz spectrum), it provides up to 590 Mbps aggregated throughput; and up to 640 Mbps with adequate channel separation (not shown here). To put these achievable throughput results into perspective, we show the relationship between estimated link range (in Kms) and MCS, based on receive sensitivity values for the 802.11ac cards in our prototype and assuming a free space pathloss (reflecting a best case link deployment scenario with LoS propagation), for different channel width combinations. With multiple channel widths are used together, the wider channels limit the range. This allows us to infer the achievable range for each of the various scenarios considered, thereby provide insight into rate-range tradeoffs. For example, considering a two interface scenario using MCS 7, the combination of 40+40 MHz provides a throughput of 215 Mbps up to a range of 5.5 Km, whereas 40+80 MHz combination reduces the maximum range to 3.9 Km but with a higher achievable throughput of 320 Mbps.

We benchmark these throughput results against the best case overall throughput, which is computed as the sum of maximum TCP throughputs achievable per interface for a given channel width and MCS in 5 GHz band in isolation, i.e., without any frequency conversion or aggregation. The corresponding throughputs obtained with WhiteHaul as a percentage of the best case overall throughput, referred to as “Conversion Efficiency”. This metric characterizes the effectiveness of frequency conversion and aggregation in WhiteHaul by comparing the throughput it achieves against the ideal case. We observe that in all combinations of 20 and 40 MHz channels, WhiteHaul TVWS conversion substrate and aggregation technique achieves 99% efficiency across all MCS values. This is because of almost perfect frequency conversion without any signal distortion and effective aggregation with our MPTCP variant. When using even wider 80 MHz channels with reduced inter-channel spacing, however, higher adjacent channel leakage lowers the efficiency. For low MCS values (up to MCS5), WhiteHaul is still able to achieve close to best performance with average efficiency of 98%. But the average efficiency drops down to 89% for higher MCS values (MCS6 and MCS7) and to the lowest level of 80% in the case of 3 immediately adjacent 80 MHz channels. However, with adequate inter-channel separation, as would be the case in a practical deployment, leads to higher efficiency. Equally, more number of interfaces and smaller widths can provide high efficiencies (results not shown here).

Impact of using 802.11ac channel widths. As we rely on 802.11ac interfaces in WhiteHaul, the set of channel widths we can use are limited to those that come with 802.11ac (which in practice are 20/40/80 MHz). We now examine the impact of restricting to these few channel widths on the use of available TVWS spectrum when ag-regating individual narrower (6/8 MHz) TVWS channels. We follow the methodology earlier used in § 2. We first obtain the amount of available TVWS spectrum in rural locations of Scotland by querying a commercial geolocation database. Then, for each of those locations, we find how much of the available spectrum can be covered by any combination of 20/40/80 MHz channel widths and supposing three 802.11ac interfaces at each WhiteHaul node. For example, suppose at a particular location, 14 TVWS channels (of size 8 MHz each) are available for WhiteHaul system but they are fragmented into two chunks of 56 MHz each. The total amount of available spectrum is 112 MHz, which can be partially utilized by two 802.11ac radios configured with 40 MHz each, and frequency converted to TVWS spectrum. Thus, the estimated utilization for that setup is (80/112) or 71.4%. In other words, the utilization represents the ratio between the actual used spectrum by the 802.11ac radios to the total amount of available TVWS spectrum, expressed as a percentage. Results show that with 3 interfaces: more than 200 MHz of spectrum can be utilized in more than 70% of the locations; and this is equivalent to nearly 80% utilization. The utilization can be improved further with additional interfaces and/or using smaller channel widths. Overall, these results indicate that using 802.11ac interfaces and their widths only have a marginal negative impact in being able to fully exploit the available TVWS spectrum.

LoRa based control interface. Here we present our experimental assessment of using LoRa based control interfaces for coordination between WhiteHaul link endpoints. To this end, we experimentally study the data rates and reliability with LoRa under wide range of radio conditions in a lab environment. For reliability, we used packet reception rate (PRR), defined as percentage of successful packet reception, as the measure. Recall that the coordination between the Master and Slave over the LoRa control interface is driven from the Master end, i.e., the Master either consults the Slave to retrieve the spectrum analysis information, or instructs the Slave to change some configurations. This makes collisions unlikely. We find that LoRa based communication is reliable with PRRs between 99.8% to 100% across a diverse range of link qualities (RSSIs ranging from −115 dBm to −70 dBm). And it achieves a data rate of 2.8 Kbps even with the very low RSSI of −115 dBm. To put these results into perspective, note that WhiteHaul endpoints need to exchange control information every few tens of seconds to aid decision making at the Master every epoch (30 s). And the size of the control commands from the Master to the Slave are quite small (few tens of bytes). The largest control message size in WhiteHaul is the spectrum sensing information from Slave to the Master with a payload size of 797 bytes but this can be exchanged at the timescale of tens of minutes. With a duty cycle of 0.8%, even this message can be delivered 2.3 seconds at the achievable data rate every 5 minutes, and other smaller messages in less than a second.

Slot allocation. Here we evaluate the dynamic time slot allocation between forward and reverse directions in WhiteHaul in comparison with static, equal time split baseline. We use the total backlogged traffic carried forward from epoch to epoch as the metric. This evaluation is based on Monte Carlo simulations (1000 iterations per data point) using MATLAB, each spanning about 8000 epochs (30 s long as per analysis in § 2) and assuming two interfaces per WhiteHaul node. Effective sub-link capacities are randomly generated within the range of 5 to 60 Mbps for this case but traffic volumes in forward and reverse directions are from the real-world network trace indicates that the dynamic time allocation approach significantly reduces the maximum backlogged traffic across the one week period from up to 30 GB with half-split approach to less than 7 GB. This improvement is also evident from the CDF plot where there is no backlogged traffic in nearly 90% of the cases with dynamic split as opposed to under 60% with half-split.

Traffic scheduling. Here we experimentally assess the effectiveness of the WhiteHaul MPTCP aggregation in a wide range of capacity and packet loss scenarios, relative to two MPTCP alternatives using coupled congestion control with OLIA [53] and uncoupled congestion control with CUBIC [36]. We approach this in two steps. We first characterize packet loss and effective capacity in different link quality conditions and with different channel widths. This characterization then is used as the basis for emulation based evaluation of WhiteHaul and other MPTCP alternatives.

Packet Loss and Capacity Characterization. Using wider channel bandwidths for high capacity TVWS backhaul links can potentially impact transmission range and cause higher susceptibility to interference due to distribution of the same power over a wider bandwidth [25]. These both manifest as increased packet loss rates, which can have adverse effect on most TCP based alternatives. We therefore conduct a controlled study to understand the nature of packet losses and effective capacities in a TVWS-based long distance setting. For this, we attenuate the transmitted TVWS signal using a combination of step attenuator and transmit power adjustment. The resulting received signal strength (RSS) values range from 80 dBm to 50 dBm, reflecting increasing link distances.

To measure the loss rate and effective capacity, we use iPerf with CBR UDP traffic streams and also experiment with three different channel widths (20, 40 and 80 MHz). On narrow channels, e.g., 20 MHz, the link has very low loss rate, almost negligible, and the maximum loss rate observed across different RSS values was 0.3%. At higher channel width, packet losses increase up to 6.9% (with 40 MHz channel). Packet loss differences between 40 MHz and 80 MHz channels are an artifact of the mechanics of underying rate adaptation mechanism. On the other hand, the effective capacity, measured in terms of UDP throughput, is expected —increasing with increasing RSS and channel width.

WhiteHaul MPTCP in Diverse Conditions. We use the observed packet loss and effective capacity results from the above study to evaluate the performance of WhiteHaul MPTCP in different conditions. We use our Linux kernel implementation for WhiteHaul and compare it with MPTCP using CUBIC [36] and OLIA [53]. The setup for this experiment consists of two Linux desktops, each with two Gigabit Ethernet interfaces. We use Linux Network Emulator (NetEm) and Traffic Control (tc) to emulate both losses and sub-link capacities from the above characterization study. It is important to note that the following performance results reflect the case of WhiteHaul MPTCP deployment in the field because the used Netem configurations are chosen based on real-world losses and capacities observed with actual WhiteHaul hardware in the above study. For WhiteHaul, we empirically set the queuing delay budget (A) as 50 ms and the target cwnd size is set as described in § 4.2.3. We use iPerf tool send uni-directional TCP traffic and measure the aggregate throughput across the two interfaces.

The results for the three alternatives as heatmaps of efficiency, defined as the ratio of achieved throughput (in presence of losses) for a given alternative—WhiteHaul, CUBIC or OLIA—to the maximum achieved throughput (without losses) with the same link capacities. We observe that CUBIC in general performs better than OLIA in presence of losses. This can be attributed to the fact that with CUBIC each sub-flow behaves independently with a separate congestion window, so the impact of packet losses of one sub-flow does not affect the congestion window of the other sub-flow. Overall though, WhiteHaul algorithm clearly achieves superior performance, by an order of magnitude, compared to both CUBIC and OLIA. In some scenarios like in the upper right corner, WhiteHaul, CUBIC and OLIA achieve aggregate throughputs of 403.8 Mbps, 31.6 Mbps and 22.3 Mbps, respectively. This significant improvement with WhiteHaul is due to two reasons. First, WhiteHaul relies on a periodic advisory signal from the slot allocation manager to keep track of the optimal target congestion window size and uses it to ramp up the rate instantly to that level and then increases linearly while keep monitoring the queuing delay. If the queuing delay exceeds the delay budget, the congestion window shrinks back again to the target value, preventing self-inflicting losses due to RTOs. Second, the WhiteHaul algorithm is robust in presence of losses to maintain sending rate close to sub-link capacities whereas CUBIC and OLIA have drastic responses to lost packets.

MPTCP use in WhiteHaul is transparent to end-to-end traffic flows (between user devices in the access network and the Internet) as it seeks to create a link-level tunnel abstraction. We evaluated the effectiveness of WhiteHaul to this end through an experiment varying number of end-to-end TCP flows. In this experiment, the WhiteHaul link consists of three sub-links respectively using 20, 40 and 80 MHz chunks and aggregate capacity of 385 Mbps. Results confirm that WhiteHaul link throughput and utilization stay unaffected by the number of end-user TCP flows, indicating no undesirable interactions between them and WhiteHaul MPTCP. Cost analysis. We close this section with a detailed cost analysis of WhiteHaul, which is primarily CAPEX, as the OPEX cost includes small nominal fee to access a commercial geolocation database. Table 1 provides a breakdown of WhiteHaul link CAPEX costs. We assume a LimeSDR based LO. The basic version consists of one interface per WhiteHaul node making up a link and costs about 1600 USD. This version can aggregate up to 10 contiguous TVWS channels (80 MHz spectrum) and provide a throughput up to 240 Mbps based on results from earlier in this section. Some items are per node and unaffected by the number of interfaces per node (combiners/splitters, antennas and compute platforms) while the rest scale with the number of interfaces. With 3 802.11ac interfaces per node, WhiteHaul link costs around 4500 USD and can deliver nearly 600 Mbps. For a marginal additional cost, we can use dual polarized Yagi antennas to get the MIMO benefits and double the achievable throughput to over 1 Gbps. Cost of our solution is comparable to existing commercial TVWS solutions (e.g., RuralConnect by Carlson Wireless, ACRS2 B1000 Adaptrum, GWS5002 by 6Harmonics, and XR by Redline) that cost around 4500-5000 USD but with an order-of-magnitude or higher throughput. The licensed commercial microwave solutions provide higher link capacity but also come with spectrum licensing cost which could be up to several tens of thousands of dollars per annum [66]. On the other hand, unlicensed commercial microwave solutions (e.g., Ubiquiti AirFiber-24-HD) costing around 3500 USD per link only operate in LoS conditions, and over relatively shorter distances. In NLoS conditions, both microwave and mmWave backhaul solutions suffer from poor performance, latter also sensitive to weather conditions. In contrast, WhiteHaul, thanks to the superior propagation characteristics in the UHF band, is better suited for NLoS settings; this can lead to cost savings through reduction in required tower heights or number of relays.

6 Related Work

TVWS Spectrum Aggregation. In IEEE 802.22 [22], the early TVWS standard targeting rural and remote areas, only a single (6/8 MHz) TVWS channel is used. In the more recent 802.11af standard framework that is aligned with regulatory requirements to use geolocation databases, aggregation up to 4 contiguous or non-contiguous TVWS channels (i.e., up to 32 MHz) is allowed [32]. The various commercial TVWS solutions that currently exist (some compliant with 802.11af) support aggregation of at most 2-3 contiguous TVWS channels [1-3, 8] with a total bandwidth less than 20 MHz. In the research literature, Holland [42] analyzes the achievable capacity with aggregating available TVWS channels with results showing promising theoretical data rate improvements but does not discuss how such rates can be achieved by a practical system.

From the systems perspective, there exists a long line of research prototyping and experimenting with TVWS platforms that use commodity 802.11 cards via frequency down-conversion [16, 43, 45, 49, 56, 62, 63]. These systems are only capable of limited TVWS spectrum aggregation (up to 4 6 MHz TVWS channels) and provide a maximum TCP (UDP) throughput of 23 Mbps (35 Mbps). In contrast, our WhiteHaul system, while leveraging the same frequency downconversion concept, achieves 500 Mbps+ TCP link throughput by enabling efficient aggregation of an order-of-magnitude more (even non-contiguous) TVWS spectrum. By focusing on the PtP backhaul use case, our work also complements the extensive TVWS systems research till date aimed at several other use cases (e.g., Wi-Fi like wireless LANs [17, 29, 89, 90], TVWS based point-to-multipoint (PtMP) for agriculture, sensor, IoT and other applications [76, 78, 86]).

Support for Spectrum Aggregation in Other Wireless Standards. The IEEE 802.11 wireless LAN (WLAN) standards have supported channel bonding (contiguous channel aggregation) since 2009 when 802.11n introduced 40 MHz bonded channels as a feature to provide high user/network data rates. This continued with the subsequent and current 802.11ac standard [19], which additionally mandates support of 80 MHz channels and operation exclusively in the 5 GHz band. 802.11ac also has optional support for contiguous 160 MHz or non-contiguous aggregation of two 80 MHz wide channels. Although the focus of 802.11 is on the WLAN setting involving communication between an AP and associated clients, equivalent to a PtMP scenario, and is largely limited to aggregation of contiguous spectrum, we leverage the 802.11 channel aggregation feature as an element in the design of WhiteHaul towards a low-cost PtP backhaul solution. On the other hand, spectrum aggregation, or more precisely carrier aggregation (CA), has also been an integral part of 3GPP cellular network standards since 2011 (Release 10) when LTE-Advanced (LTE-A) was introduced [58, 81]. The essential idea behind the CA is to aggregate two or more component carriers (CCs) of different bandwidths (between 1.4 MHz and 20 MHz) up to 100 MHz with five CCs of 20 MHz. The target usage scenario for CA is different from ours on PtMP and the focus there is mainly on how to select the CCs and schedule resource blocks to users across CCs. CA also limits the amount of spectrum that can aggregated to 100 MHz. Other physical layer aggregation approaches have been proposed in [46, 84] to utilize multiple spectrum fragments using one radio and incorporating frequency reshaping techniques. Their target use case is again different with focus on enabling coexistence between different technologies in narrow shared spectrum. Moreover, the use of a single radio limits the aggregated spectrum to 40 MHz in these works.

Higher Layer Aggregation Approaches. Other aggregation techniques exist at higher layers, such as MPTCP at transport layer [33, 34], Multipath QUIC (MP-QUIC) [24, 87] at application/transport layer, and LTE-WLAN Aggregation (LWA) at LTE PDCP layer [14]. Different from the lower layer techniques, these approaches can be technology agnostic which allows more flexible aggregation not only between transceivers of the same technology but also across different technologies. In recent years, there have been several traffic scheduling algorithms proposed in this context targeting heterogeneous settings and considering different characteristics (bandwidth, latency, etc.) [30, 35, 38, 55, 59]. In contrast to the above works, our WhiteHaul system takes a cross-layer/hybrid aggregation approach combining the lower layer aggregation capability with a higher layer technique, the latter in our case realized using MPTCP variant with new tailored uncoupled congestion control algorithm.

7 Conclusions

We have presented WhiteHaul, a cost-effective and efficient system for high-speed backhaul over TVWS spectrum. WhiteHaul is the first TVWS system that is capable of aggregating the whole UHF band, utilizing both the contiguous and non-contiguous chunks of available spectrum. WhiteHaul is made up of innovations across both hardware and software. The hardware layer is represented by a conversion substrate that leverages SDR-based local oscillator to down/up-convert between available TVWS spectrum and 5 GHz Wi-Fi channels, and to effectively combine non-contiguous chunks of TVWS spectrum. The WhiteHaul software layer orchestrates the underlying COTS Wi-Fi interfaces to maximize throughput by efficiently distributing traffic among them. It features a novel use of MPTCP along with a novel cross-layer congestion control algorithm to quickly and efficiently utilize available capacity across sub-links. Our extensive lab evaluations of WhiteHaul using a prototype implementation we developed show that WhiteHaul can aggregate almost the whole TV band and can achieve nearly 600 Mbps TCP throughput using a single antenna, and its MPTCP component outperforms the state-of-the-art by an order of magnitude. Our future work will focus on real-world trials of WhiteHaul as well as examining its wider applicability beyond the TVWS spectrum.

### REFERENCES

[1] 6Harmonics. http://www.6harmonics.com/.
[2] Adaptrum. http://www.adaptrum.com/.
[3] Carlson Wireless Technologies. https://www.carlsonwireless.com/.
[4] Facebook Connectivity. https://connectivity.fb.com/high-altitude-connectivity/.
[5] FSOC. https://x.company/projects/fsoc/.
[6] MLVPN. https://mlvpn.readthedocs.io/en/latest/what_is_mlvpn.html.
[7] Pycom—Next Generation Internet of Things Platform. https://pycom.io/.
[8] Redline Communications. https://rdlcom.com/tv-white-space/.
[9] RF Explorer. http://j3.rf-explorer.com/.
[10] Tegola Rural Community Wireless Access Network. http://www.tegola.org.uk/networks.html.
[11] Universal TUN/TAP device driver. https://www.kernel.org/doc/Documentation/networking/tuntap.txt.
[12] USRP B210. http://www.ettus.com/all-products/UB210-KIT/.
[13] Measuring the Information Society Report 2018, 2018. https://www.itu.int/en/ITU-D/Statistics/Pages/publications/misr2018.aspx/.
[14] 3GPP:REL.14. Evolved Universal Terrestrial Radio Access (E-UTRA); Packet Data Convergence Protocol (PDCP) specification. Retrieved July, 2018 from https://www.etsi.org/deliver/etsi_ts/136300_136399/136323/14. 03.00_60/ts_136323v140300p.pdf.
[15] Anand, A., Pejovic, V., Belding, E. M., and Johnson, D. L. VillageCell: Cost effective cellular connectivity in rural areas. In Proceedings of the Fifth International Conference on Information and Communication Technologies and Development (2012), ACM, pp. 180-189.
[16] Ashok, A., Subbiah, I., Varga, G., Schrey, M., Achtzehn, A., Petrova, M., and Heinen, S. Whitelan: Facilitate cost-efficient SDR research with COTS IEEE 802.11 b/g devices. In ACM SIGCOMM Computer Communication Review (2014), vol. 44, ACM, pp. 45-52.
[17] Bahl, P., Chandra, R., Moscibroda, T., Murty, R., and Welsh, M. White space networking with wi-fi like connectivity. ACM SIGCOMM Computer Communication Review 39, 4 (2009), 27-38.
[18] Baig, G., Alistarh, D., Karagiannis, T., Radunovic, B., Balkwill, M., and Qiu, L. Towards unlicensed cellular networks in TV white spaces. In Proceedings of the 13th International Conference on emerging Networking EXperiments and Technologies (2017), ACM, pp. 2-14.
[19] Bejarano, O., Knightly, E., and Park, M. IEEE 802.11ac: From Channelization to Multi-User MIMO. IEEE Communications 51, 10 (October 2013).
[20] Biggs, P., and Lozanova, Y. THE STATE OF BROADBAND 2017: BROADBAND CATALYZING SUSTAINABLE DEVELOPMENT, September 2017. https://www.itu.int/dms_pub/itu-s/opb/pol/S-POL-BROADBAND.18-2017-PDF-E.pdf.
[21] Chandra, R., Moscibroda, T., Bahl, P., Murty, R., Nychis, G., and Wang, X. A campus-wide testbed over the TV white spaces. ACM SIGMOBILE Mobile Computing and Communications Review 15, 3 (2011), 2-9.
[22] Cordeiro, C., Challapali, K., Birru, D., and Shankar, S. IEEE 802.22: the first worldwide wireless standard based on cognitive radios. In First IEEE International Symposium on New Frontiers in Dynamic Spectrum Access Networks, 2005. DySPAN 2005. (2005), IEEE, pp. 328-337.
[23] De Coninck, Q., Baerts, M., Hesmans, B., and Bonaventure, O. A first analysis of multipath TCP on smartphones. In International Conference on Passive and Active Network Measurement (2016), Springer, pp. 57-69.
[24] De Coninck, Q., and Bonaventure, O. Multipath QUIC: Design and Evaluation. In Proceedings of the 13th International Conference on Emerging Networking EXperiments and Technologies (2017), ACM, pp. 160-166.
[25] Deek, L., Garcia-Villegas, E., Belding, E., Lee, S.-J., and Almeroth, K. The impact of channel bonding on 802.11 n network management. In Proceedings of the Seventh COnference on emerging Networking EXperiments and Technologies (2011), ACM, p. 11.
[26] Djukic, P., and Mohapatra, P. Soft-TDMAC: A software TDMA-based MAC over commodity 802.11 hardware. In INFOCOM 2009, IEEE (2009), IEEE, pp. 1836-1844.
[27] Ericsson, Ericsson Mobility Report June 2019, June 2019. https://www. eicsson.com/en/mobility-report/reports/june-2019.
[28] ETSI. White Space Devices (WSD) Wireless Access Systems operating in the 470 MHz to 790 MHz TV broadcast band, 2018. ETSI EN 301 598 V2.1.1.
[29] Feng, X., Zhang, J., and Zhang, Q. Database-assisted multi-AP network on TV white spaces: Architecture, spectrum allocation and AP discovery. In 2011 IEEE International Symposium on Dynamic Spectrum Access Networks (DySPAN) (2011), IEEE, pp. 265-276.
[30] Ferlin, S., Alay, O., Mehani, O., and Boreli, R. BLEST: Blocking estimation-based MPTCP scheduler for heterogeneous networks. In IFIP Networking Conference (IFIP Networking) and Workshops, 2016 (2016), IEEE, pp. 431-439.
[31] Flickenger, R., Okay, S., Pietrosemoli, E., Zennaro, M., and Fonda, C. Very long distance Wi-Fi networks. In Proceedings of the second ACM SIGCOMM workshop on Networked systems for developing regions (2008), pp. 1-6.
[32] Flores, A. B., Guerra, R. E., Knightly, E. W., Ecclesine, P., and Pandey, S. IEEE 802.11 af: A standard for TV white space spectrum sharing. IEEE Communications Magazine 51, 10 (2013), 92-100.
[33] Ford, A., Raiciu, C., Handley, M., Barre, S., lyengar, J., et al. Architectural guidelines for Multipath TCP development. IETF, Informational RFC 6182 (2011), 2070-1721.
[34] Ford, A., Raiciu, C., Handley, M., and Bonaventure, O. TCP extensions for multipath operation with multiple addresses. Internet Engineering Task Force (2013).
[35] Guo, Y. E., Nikravesh, A., Mao, Z. M., Qian, F., and Sen, S. Accelerating multipath transport through balanced subflow completion. In Proceedings of the 23rd Annual International Conference on Mobile Computing and Networking (2017), ACM, pp. 141-153.
[36] Ha, S., Rhee, I., and Xu, L. CUBIC: a new TCP-friendly high-speed TCP variant. ACM SIGOPS operating systems review 42, 5 (2008), 64-74.
[37] Harrison, K., Mishra, S. M., and Sahai, A. How much white-space capacity is there? In New Frontiers in Dynamic Spectrum, 2010 IEEE Symposium on (2010), IEEE, pp. 1-10.
[38] Hartung, L., and Milind, M. Policy driven multi-band spectrum aggregation for ultra-broadband wireless networks. In Dynamic Spectrum Access Networks (DySPAN), 2015 IEEE International Symposium on (2015), IEEE, pp. 82-93.
[39] Hasan, S., Barela, M. C., Johnson, M., Brewer, E., and Heimeri, K. Scaling community cellular networks with CommunityCellularManager. In 16th USENIX Symposium on Networked Systems Design and Implementation (NSDI 19) (2019), pp. 735-750.
[40] Hasan, S., Heimerl, K., Harrison, K., Ali, K., Roberts, S., Sahai, A., and Brewer, E. GSM Whitespaces: An opportunity for rural cellular service. In 2014 IEEE International Symposium on Dynamic Spectrum Access Networks (DYSPAN) (2014), IEEE, pp. 271-282.
[41] Heimerl, K., Hasan, S., Ali, K., Brewer, E., and Parikh, T. Local, Sustainable, Small-Scale Cellular Networks. In Proceedings of the Sixth International Conference on Information and Communication Technologies and Development: Full Papers-Volume 1 (2013), ACM, pp. 2-12.
[42] Holland, O. Some are born with white space, some achieve white space, and some have white space thrust upon them. IEEE Transactions on Cognitive Communications and Networking 2, 2 (2016), 178-193.
[43] Holland, O., Aijaz, A., Ping, S., Wong, S., Mack, J., Lam, L., and de la Fuente, A. Aggregation in TV white space and assessment of an aggregation-capable IEEE 802.11 white space device. In Communications (ICC), 2016 IEEE International Conference on (2016), IEEE, pp. 1-5.
[44] Holland, O., Ping, S., Aijaz, A., Chareau, J.-M., Chawdhry, P., Gao, Y., Qin, Z., and Kokkinen, H. To white space or not to white space: That is the trial within the Ofcom TV white spaces pilot. In 2015 IEEE International Symposium on Dynamic Spectrum Access Networks (DySPAN) (2015), IEEE, pp. 11-22.
[45] Holland, O., Raman, A., Sastry, N., Wong, S., Mack, J., and Lam, L. Assessment of a Platform for Non-Contiguous Aggregation of IEEE 802.11 Waveforms in TV White Space. In 2016 IEEE 83rd Vehicular Technology Conference (VTC Spring) (2016), IEEE, pp. 1-5.
[46] Hong, S. S., Mehlman, J., and Katti, S. Picasso: flexible RF and spectrum slicing. ACM SIGCOMM Computer Communication Review 42, 4 (2012), 37-48.
[47] Ireland, T., Nyzio, A., Zink, M., and Kurose, J. The impact of directional antenna orientation, spacing, and channel separation on long-distance multi-hop 802.11 g networks: A measurement study. In 2007 5th International Symposium on Modeling and Optimization in Mobile, Ad Hoc and Wireless Networks and Workshops (2007), IEEE, pp. 1-6.
[48] John Magliacane. SPLAT!: an RF Signal Propagation, Loss, And Terrain analysis tool. http://www.qsl.net/kd2bd/splat.html.
[49] Johnson, D., Zlobinsky, N., Lysko, A., Lamola, M., Hadzic, S., Maliwatu, R., and Densmore, M. Head to Head Battle of TV White Space and WiFi for Connecting Developing Regions. In e-Infrastructure and e-Services for Developing Countries: 8th International Conference, AFRICOMM 2016, Ouagadougou, Burkina Faso, Dec. 6-7, 2016, Proceedings (2017), vol. 208, Springer, p. 186.
[50] Johnson, D. L., and Mikeka, C. Bridging Africa's broadband divide. IEEE Spectrum 53, 9 (2016), 42-56.
[51] Kassem, M. M., Marina, M. K., and Radunovic, B. DIY model for mobile network deployment: A step towards 5G for all. In Proceedings of the 1st ACM SIGCAS Conference on Computing and Sustainable Societies (2018), pp. 1-5.
[52] Khalil, M., Qadir, J., Onireti, O., Imran, M. A., and Younis, S. Feasibility, architecture and cost considerations of using TVWS for rural Internet access in 5G. In 2017 20th Conference on Innovations in Clouds, Internet and Networks (ICIN) (2017), IEEE, pp. 23-30.
[53] Khalili, R., Gast, N., Popovic, M., and Le Boudec, J.-Y. MPTCP is Not Pareto-optimal: Performance Issues and a Possible Solution. IEEE/ACM Trans. Netw. 21, 5 (2013), 1651-1665.
[54] Kirkpatrick, K. Bringing the Internet to the (Developing) World. Commun. ACM 61, 7 (June 2018), 20-21.
[55] Kuhn, N., Lochin, E., Mifdaoui, A., Sarwar, G., Mehani, O., and Boreli, R. DAPS: Intelligent delay-aware packet scheduling for multipath transport. In Communications (ICC), 2014 IEEE International Conference on (2014), IEEE, pp. 1222-1227.
[56] Kumar, A., Karandikar, A., Naik, G., Khaturia, M., Saha, S., Arora, M., and Singh, J. Toward enabling broadband for a billion plus population with TV white spaces. IEEE Communications Magazine 54, 7 (2016), 28-34.
[57] Kumbhkar, R., Islam, M. N., Mandayam, N. B., and Seskar, I. Rate optimal design of a wireless backhaul network using TV white space. In 2015 7th International Conference on Communication Systems and Networks (COMSNETS) (2015), IEEE, pp. 1-7.
[58] Lee, H., Vahid, S., and Moessner, K. A Survey of Radio Resource Management for Spectrum Aggregation in LTE-Advanced. IEEE Communications Surveys & Tutorials 16, 2 (2014).
[59] Lim, Y.-s., Nahum, E. M., Towsley, D., and Gibbens, R. J. ECF: An MPTCP path scheduler to manage heterogeneous paths. In Proceedings of the 13th International Conference on emerging Networking EXperiments and Technologies (2017), ACM, pp. 147-159.
[60] Liu, B., Yi, X., Yang, K., Liang, Z., Feng, G., Choi, P., Boon, C. C., and Li, C. A Carrier Aggregation Transmitter Front End for 5-GHz WLAN 802.11 ax Application in 40-nm CMOS. IEEE Transactions on Microwave Theory and Techniques (2019).
[61] MacCartney, G. R., and Rappaport, T. S. Rural macrocell path loss models for millimeter wave wireless communications. IEEE Journal on selected areas in communications 35, 7 (2017), 1663-1677.
[62] Mack, J., and Cartmell, J. Field trial results for a Wi-Fi based spectrum sharing technology in TVWS. In IEEE Long Island Systems, Applications and Technology (LISAT) Conference 2014 (2014), IEEE, pp. 1-6.
[63] Narlanka, S., Chandra, R., Bahl, P., and Ferrell, J. I. A hardware platform for utilizing TV bands with a Wi-Fi radio. In Local & Metropolitan Area Networks, 2007.

LANMAN 2007. 15th IEEE Workshop on (2007), IEEE, pp. 49-53.
[64] Nikravesh, A., Guo, Y., Qian, F., Mao, Z. M., and Sen, S. An in-depth understanding of multipath TCP on mobile devices: Measurement and system design. In Proceedings of the 22nd Annual International Conference on Mobile Computing and Networking (2016), pp. 189-201.
[65] OECD. International Cables, Gateways, Backhaul and International Exchange Points. OECD Digital Economy Papers, No. 232, OECD Publishing, Paris (2014).
[66] Ofcom. Fees for Spectrum Access 28 GHz Licences. https://www.ofcom.org.uk/data/assets/pdf_file/0028/80938/28_ghz_fee_statement.pdf, December 2015.
[67] Ofcom. Airwaves opened up to support wireless revolution, July 2019. https://www.ofcom.org.uk/about-ofcomAatest/features-and-news/airwaves-opened-up-to-support-wireless-revolution.
[68] Panigrahi, D., and Raman, B. TDMA scheduling in long-distance WiFi networks. In IEEE INFOCOM 2009 (2009), IEEE, pp. 2931-2935.
[69] Park, C. S., Sundström, L., Wallén, A., and Khayrallah, A. Carrier aggregation for LTE-advanced: Design challenges of terminals. IEEE Communications Magazine 51, 12 (2013), 76-84.
[70] Patra, R. K., Nedevschi, S., Surana, S., Sheth, A., Subramanian, L., and Brewer, E. A. WLDNet Design and Implementation of High Performance WiFi Based Long Distance Networks. In NSDI (2007), vol. 1, p. 1.
[71] Raiciu, C., Handley, M., and Wschik, D. Coupled congestion control for multipath transport protocols. Tech. rep., IETF RFC 6356, October, 2011.
[72] Raman, B., and Chebrolu, K. Experiences in using WiFi for rural internet in India. IEEE Communications Magazine 45, 1 (2007), 104-110.
[73] Raul Katz. The Impact of Broadband on the Economy: Research to Date and Policy Issues, April 2012. https://www.itu.int/ATU-D/treg/broadband/ATU-BB-Reports_Impact-of-Broadband-on-the-Economy.pdf.
[74] Raza, U., Kulkami, P., and Sooriyabandara, M. Low Power Wde Area Networks: An overview. IEEE Communications Surveys & Tutorials 19, 2 (2017), 855-873.
[75] Reigadas, J. S., Martinez-Fernandez, A., Ramos-Lopez, J., and Seoane-Pascual, J. Modeling and optimizing IEEE 802.11 DCF for long-distance links. IEEE Transactions on Mobile Computing 9, 6 (2010), 881-896.
[76] Roberts, S., Gamett, P., and Chandra, R. Connecting Africa using the TV white spaces: From research to real world deployments. In The 21st IEEE International Workshop on Local and Metropolitan Area Networks (2015), IEEE, pp. 1-6.
[77] Saha, S. K., Kannan, A., Lee, G., Ravichandran, N., Medhe, P. K., Merchant, N., and Koutsonikolas, D. Multipath TCP in smartphones: Impact on performance, energy, and CPU utilization. In Proceedings of the 15th ACM International Symposium on Mobility Management and Wireless Access (2017), pp. 23-31.
[78] Saifullah, A., Rahman, M., Ismail, D., Lu, C., Liu, J., and Chandra, R. Low-Power Wde-Area Network Over White Spaces. IEEE/ACM Trans. Netw. 26, 4 (August 2018), 1893-1906.
[79] Schmitt, P., Iland, D., Zheleva, M., and Belding, E. HybridCell: Cellular connectivity on the fringes with demand-driven local cells. In IEEE INFOCOM 2016—The 35th Annual IEEE International Conference on Computer Communications (2016), IEEE, pp. 1-9.
[80] Sevilla, S., Johnson, M., Kosakanchit, P., Liang, J., and Heimerl, K. Experiences: Design, Implementation, and Deployment of CoLTE, a Community LTE Solution. In The 25th Annual International Conference on Mobile Computing and Networking (2019), ACM, p. 45.
[81] Shen, Z., Papasakellariou, A., Montojo, J., Gerstenberger, D., and Xu, F. Overview of 3GPP LTE-Advanced Carrier Aggregation for 4G Wireless Communications. IEEE Communications 50, 2 (February 2012).
[82] Sheth, A., Nedevschi, S., Patra, R., Surana, S., Brewer, E., and Subramanian, L. Packet loss characterization in WiFi-based long distance networks. In IEEE INFOCOM 2007-26th IEEE International Conference on Computer Communications (2007), IEEE, pp. 312-320.
[83] Talbot, D. The Unacceptable Persistence of the Digital Divide. MIT Technology Review, December 2016. https://www.technologyreview.com/s/603083/the-unacceptable-persistence-of-the-digital-divide/.
[84] Tan, K., Shen, H., Zhang, J., and Zhang, Y. Enable flexible spectrum access with spectrum virtualization. In 2012 IEEE International Symposium on Dynamic Spectrum Access Networks (2012), IEEE, pp. 47-58.
[85] Van De Beek, J., Riihijarvi, J., Achtzehn, A., and Mahonen, P. TV white space in Europe. IEEE Transactions on Mobile Computing 11, 2 (2012), 178-188.
[86] Vasisht, D., Kapetanovic, Z., Won, J., Jin, X., Chandra, R., Sinha, S., Kapoor, A., Sudarshan, M., and Stratman, S. Farmbeats: An IoT platform for data- driven agriculture. In 14th USENIX Symposium on Networked Systems Design and Implementation (NSDI 17) (2017), pp. 515-529.
[87] Viemickel, T., Froemmgen, A., Rizk, A., Koldehofe, B., and Steinmetz, R. Multipath QUIC: A deployable multipath transport protocol. In 2018 IEEE International Conference on Communications (ICC) (2018), IEEE, pp. 1-7.
[88] Yaacoub, E., and Alouini, M. Connecting the Remaining 4 Billions: A Survey on Rural Connectivity. CoRR abs/1906.11541 (2019).
[89] Ying, X., Zhang, J., Yan, L., Zhang, G., Chen, M., and Chandra, R. Exploring indoor white spaces in metropolises. In Proceedings of the 19th annual international conference on Mobile computing & networking (2013), ACM, pp. 255-266.
[90] Zhang, J., Zhang, W., Chen, M., and Wang, Z. WINET: Indoor white space network design. In 2015 IEEE Conference on Computer Communications (INFO-COM) (2015), IEEE, pp. 630-638.
[91] Zheleva, M., Paul, A., Johnson, D. L., and Belding, E. Kwiizya: Local Cellular Network Services in Remote Areas. In Proceedings of ACM MobiSys (2013), ACM, pp. 417-430.

1. A computer implemented method for efficient aggregation of a Television White Space (TVWS) spectrum for backhaul use, said method comprising:
providing a TVWS conversion substrate with a single antenna for combining multiple non-contiguous chunks of TVWS spectrum with said single antenna;
providing a Multi-Path transport protocol; and
providing an uncoupled, cross-layer congestion control algorithm for Multi-path Transmission Control Protocol (MPTCP).

2. The method of claim 1, wherein the method comprises a further step of providing an algorithm that incorporates a geolocation database, spectrum analyzer and radio frequency (RF) signal propagation, loss and terrain analysis tool to decide on the list of TVWS contiguous and non-contiguous chunks that can be used in given setup.

3. The method of claim 1, wherein the step of providing a Multi-Path transport protocol comprises providing a Multi-Path transport protocol based software layer aggregation of multiple TVWS spectrum chunks.

4. The method of claim 1, wherein the Multi-Path transport protocol is a Multi-Path Transmission Control Protocol (MPTCP).

5. The method according to claim 1, wherein the single antenna is a dual polarized antenna.

6. The method according to claim 1, wherein the single antenna has a height, and the height is no more than 125 m, preferably not more than 100 m and more preferably not more than 30 m.

7. The method according to claim 1, wherein the method further comprises providing a software-defined radio (SDR)-based local oscillator.

8. The method according to claim 1, wherein the method further comprises providing a voltage controlled oscillator (VCO).

9. The method according to claim 1, wherein the method further comprises providing a Local Oscillator (LO).

10. The method according to claim 1, wherein the method further comprises providing at least one Wi-Fi interface based on IEEE 802.11 standard operating in the 5 GHz band.

11. The method according to claim 1, wherein the method further comprises providing a long range (LoRa) control interface.

12. A computing system configured to implement the method of claim 1.

13. A data processing apparatus comprising means for carrying out the method of claim 1.

14. A data processing apparatus comprising a processor configured to perform the method of claim 1.

15. A data processing apparatus comprising means for carrying out the method of claim 1.

16. A computer program product comprising instructions which, when the program is executed by a computer, cause the computer to carry out the method of claim 1.

17. A computer-readable medium comprising instructions which, when executed by a computer, cause the computer to carry out the method of claim 1.

18. A computer-readable data carrier, having stored thereon the computer program product of claim 16.

19. A data carrier signal carrying the computer program product of claim 16.

20. A non-transitory computer readable media having stored thereon software instructions that, when executed by a processor, cause the processor to carry out the method of claim 1.
